(19) United States
(12) Patent Application Publication
(10) Pub. No.: US 2025/0333053 A1
(43) Pub. Date: Oct. 30, 2025

(54) CHECK DEVICE AND CHECK METHOD

(71) Applicant: DENSO CORPORATION, Kariya-city (JP)

(72) Inventors: KENTO OISHI, Kariya-city (JP); ATSUSHI BABA, Kariya-city (JP)

(21) Appl. No.: 19/259,036

(22) Filed: Jul. 3, 2025

Related U.S. Application Data
(63) Continuation of application No. PCT/JP2023/034881, filed on Sep. 26, 2023.

(30) Foreign Application Priority Data
Jan. 9, 2023 (JP) 2023-001415

(51) Int. Cl. B60W 30/095; B60W 30/16; B60W 50/00; B60W 50/14

(52) U.S. Cl. CPC B60W 30/0956; B60W 30/16; B60W 50/0097; B60W 50/14; B60W 2050/146; B60W 2554/4045; B60W 2554/801; B60W 2554/802

(57) ABSTRACT

A check device used for driving of a vehicle includes at least one processor and a non-transitory computer-readable storage medium storing instructions. The at least one processor is configured to execute assuming a trajectory along which a moving object passing through a lane in which the vehicle is present is predicted to travel such that the trajectory includes an inside of the lane; and checking a collision risk between the vehicle and the moving object, by treating at least a part of a region occupied by the trajectory as a separate lane other than the lane in which the vehicle is present.

### CROSS REFERENCE TO RELATED APPLICATION

The present application is a continuation application of International Patent Application No. PCT/JP2023/034881 filed on Sep. 26, 2023 which designated the U.S. and claims the benefit of priority from Japanese Patent Application No. 2023-001415 filed on Jan. 9, 2023. The entire disclosures of all of the above applications are incorporated herein by reference.

### TECHNICAL FIELD

The present disclosure relates to driving of a vehicle.

### BACKGROUND

A processor in a related art predicts a trajectory of a moving object in the vicinity of a vehicle, and determines whether a risk value indicating a collision risk between the vehicle and the moving object exceeds a risk threshold value defined in advance. The processor then generates information for determining a safe driving state for the vehicle, based on a determination that the collision risk exceeds the risk threshold value. In the determination as to the risk, for example, when a sensed distance between the vehicle and the moving object is less than a minimum safety distance, the vehicle is determined to be unsafe.

### SUMMARY

A check device used for driving of a vehicle includes at least one processor and a non-transitory computer-readable storage medium storing instructions. The at least one processor is configured to execute assuming a trajectory along which a moving object passing through a lane in which the vehicle is present is predicted to travel such that the trajectory includes an inside of the lane; and checking a collision risk between the vehicle and the moving object, by treating at least a part of a region occupied by the trajectory as a separate lane other than the lane in which the vehicle is present.

### BRIEF DESCRIPTION OF DRAWINGS

Objects, features and advantages of the present disclosure will become more apparent from the following detailed description made with reference to the accompanying drawings. In the drawings:

FIG. 1 is a diagram illustrating a schematic configuration of a driving system;

FIG. 2 is a diagram illustrating a hardware configuration of the driving system;

FIG. 3 is a diagram illustrating a longitudinal safety distance;

FIG. 4 is a diagram illustrating an expression for the longitudinal safety distance;

FIG. 5 is a diagram illustrating the longitudinal safety distance;

FIG. 6 is a diagram illustrating the expression for the longitudinal safety distance;

FIG. 7 is a diagram illustrating a lateral safety distance;

FIG. 8 is a diagram illustrating an expression for the lateral safety distance;

FIG. 9 is a diagram illustrating a lane-based coordinate system;

FIG. 10 is a flowchart illustrating a process by the driving system;

FIG. 11 is a diagram illustrating an example of a scenario in which a passing-through moving object is present;

FIG. 12 is a diagram illustrating an expression related to an assumption on a travel route;

FIG. 13 is a diagram illustrating an expression related to the assumption on the travel route;

FIG. 14 is a diagram illustrating the example of the scenario in which the passing-through moving object is present;

FIG. 15 is a diagram illustrating an expression related to the assumption on the travel route;

FIG. 16 is a diagram illustrating the example of the scenario in which the passing-through moving object is present;

FIG. 17 is a diagram illustrating the example of the scenario in which the passing-through moving object is present;

FIG. 18 is a diagram illustrating an example of a scenario in which a passing-through moving object is assumed;

FIG. 19 is a diagram illustrating the example of the scenario in which the passing-through moving object is assumed;

FIG. 20 is a flowchart illustrating the process performed by the driving system;

FIG. 21 is a diagram illustrating the schematic configuration of the driving system;

FIG. 22 is a diagram illustrating the schematic configuration of the driving system;

FIG. 23 is a state transition diagram illustrating a state transition of a vehicle;

FIG. 24 is a diagram illustrating the example of the scenario in which the passing-through moving object is assumed;

FIG. 25 is a diagram illustrating the example of the scenario in which the passing-through moving object is assumed;

FIG. 26 is a diagram illustrating the example of the scenario in which the passing-through moving object is present; and

FIG. 27 is a diagram illustrating the example of the scenario in which the passing-through moving object is present.

### DETAILED DESCRIPTION

For example, on a road during traffic congestion, on a road in emerging countries or densely populated areas, and the like, a moving object, for example, a motorcycle, a bicycle, a pedestrian, or the like may travel through the same lane as the lane in which the vehicle travels. In such a scenario, when the collision risk with the moving object is determined under the same conditions as for a normal vehicle, there is a concern that excessive vehicle responses may occur frequently, for example. There is also concern that a processing load related to the collision risk with the moving object will be increased.

The present disclosure provides a check device and a check method for improving validity of handling a moving object traveling through a lane.

One embodiment disclosed herein includes a check device used for driving of a vehicle, including at least one processor. The processor is configured to execute assuming a trajectory along which a moving object passing through a lane in which the vehicle is present is predicted to travel such that the trajectory includes an inside of the lane, and checking a collision risk between the vehicle and the moving object by treating at least a part of a region occupied by the trajectory as a separate lane other than the lane in which the vehicle is present.

Another aspect of the disclosed embodiment is a method for checking the collision risk of a vehicle, executed by at least one processor, including: assuming a trajectory along which a moving object passing through a lane in which the vehicle is present is predicted to travel such that the trajectory includes an inside of the lane; and checking the collision risk between the vehicle and the moving object by treating at least a part of a region occupied by the trajectory as a separate lane other than the lane in which the vehicle is present.

With these aspects, a region occupied by the trajectory of the moving object traveling through a lane in which the vehicle is present is treated as a lane separate from the lane in which the vehicle is present. This makes it possible to reasonably process a predicted behavior of the passing-through moving object while reducing a processor load caused by processing a situation in which many moving objects are in the traffic congestion in the same lane. It is possible to reduce frequent occurrence of excessive responses of the vehicle that may result from a risk check. In this manner, when checking the collision risk with the moving object traveling through a lane, validity for the moving object can be improved.

Another aspect of the disclosed embodiments includes a check device used for driving a vehicle, including at least one processor. The processor is configured to execute: checking a collision risk between the vehicle and another road user; determining whether to execute a proper response including braking, when the collision risk is determined to be higher than a preset threshold value; changing a condition for determining the collision risk such that the collision risk is determined to be higher when the other road user is in the same lane as the vehicle than when the other road user is in a separate lane from the vehicle; assuming a moving object passing through a lane in which the vehicle is present as the other road user; and treating, in the determining of the collision risk, the moving object as being present in a separate lane other than the lane in which the vehicle is present even when the moving object is present in the lane in which the vehicle is present.

With this aspect, a condition for determining the collision risk with respect to a passing-through moving object is a condition with which the collision risk is determined to be lower, in the same manner as other road users present in a separate lane from the vehicle. As a result, since a possibility that the collision risk is determined to be higher than a preset threshold value becomes low, it becomes difficult to reach a situation for determining whether to execute a proper response, including braking. Therefore, it is possible to reduce frequent occurrence of excessive responses to the passing-through moving object. In this manner, when checking the collision risk with the moving object traveling through a lane, validity for the moving object can be improved.

Multiple embodiments will be described based on the drawings. Duplicate description may be omitted by assigning the same reference numerals to the corresponding elements in each embodiment. When only a part of a configuration is described in each embodiment, the configurations of the other embodiments described above can be applied to the other parts of the configuration. Not only the combinations of the configurations explicitly illustrated in the description of each embodiment, but also the configurations of multiple embodiments can be partially combined even when they are not explicitly illustrated when there is no problem in the combination in particular.

In the following multiple embodiments, contents of “Safety First for Automated Driving” Tech.Rep., 2019. by Aptiv, Audi, Baidu, BMW, Continental, Daimler, FCA, here, Infineon, Intel, and Volkswagen, contents of “On a formal model of safe and scalable self-driving cars”, arXiv: 1708.06374, 2017. by S. Shalev-Shwartz, S. Shammah, and A. Shashua, contents of “The Safety Force Field” Technical Report, 2019. by David Nister, Hon-Leung Lee, Julia Ng, Yizhou Wang, contents of IEEE 2846-2022 are incorporated by reference in their entirety.

### First Embodiment

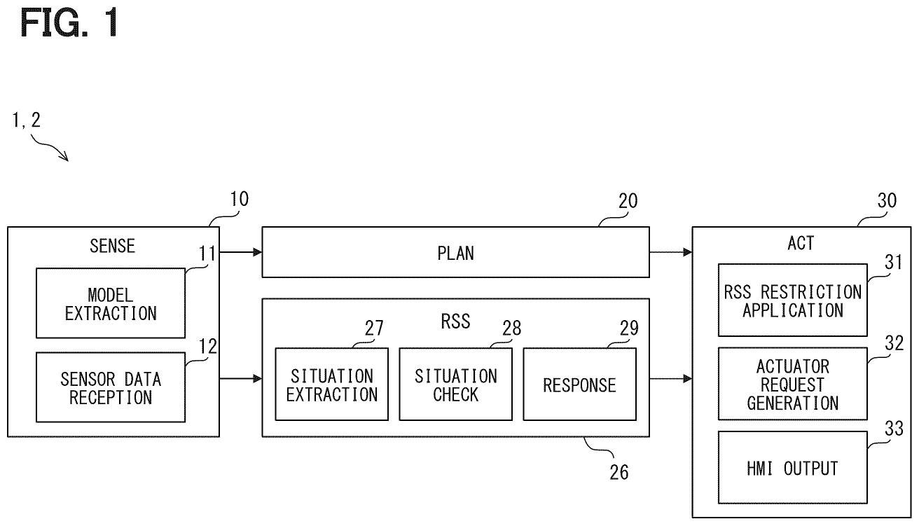

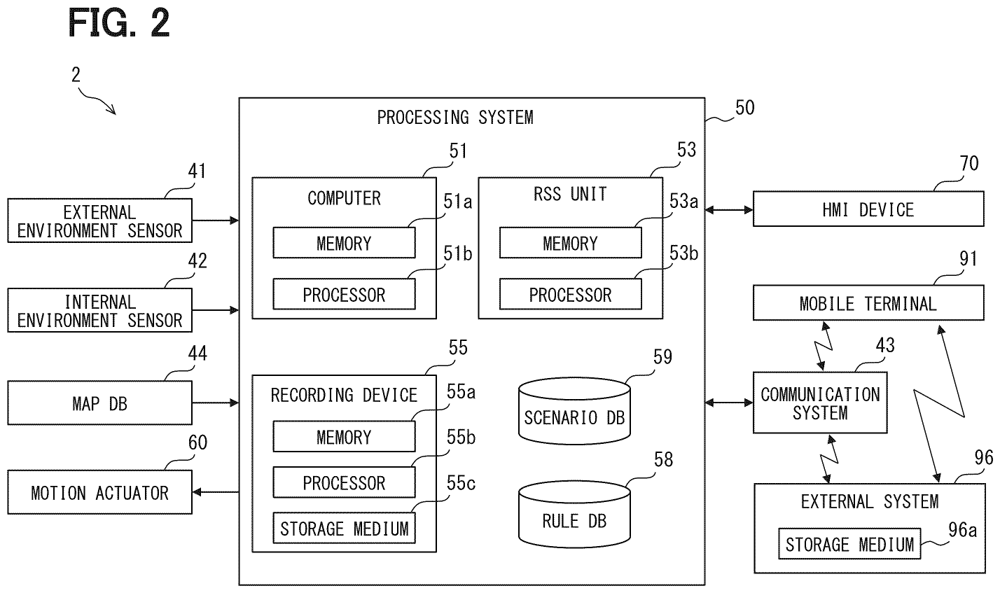

A driving system 2 of a first embodiment illustrated in FIG. 1 and FIG. 2 realizes a function related to driving of a moving object. A part or all of the driving system 2 is mounted in the moving object. The moving object that is a target to be processed by the driving system 2 is a vehicle 1. This vehicle 1 may be referred to as an ego-vehicle, a host vehicle, or the like. The vehicle 1 may be configured to communicate with another vehicle or the like directly or indirectly via communication infrastructure. The other vehicle is referred to as a target vehicle in some cases.

The vehicle 1 may be, for example, a road user capable of executing manual driving of a four-wheeled automobile or a truck. The vehicle 1 may further be capable of executing automated driving. Levels of the driving are classified in accordance with a range or the like of tasks executed by a driver, among all dynamic driving tasks (DDTs). The automated driving level is defined, for example, in SAE J3016. At levels 0 to 2, the driver performs a part or all of the DDT. Levels 0 to 2 may be classified as so-called manual driving. Level 0 indicates that driving is not automated. Level 1 indicates that the driving system 2 supports the driver. Level 2 indicates that driving is partially automated.

At level 3 or higher, the driving system 2 performs all of the DDTs while being engaged. Levels 3 to 5 may be classified as so-called automated driving. A system capable of executing driving at level 3 or higher may be referred to as automated driving systems. A vehicle mounted with an automated driving system or a vehicle capable of executing driving at level 3 or higher may be referred to as an automated vehicle (AV). Level 3 indicates that driving is conditionally automated. Level 4 indicates that driving is highly automated. Level 5 indicates that driving is fully automated.

The driving system 2 that is not capable of executing driving of level 3 or higher and that is capable of executing driving of at least one of levels 1 and 2 may be referred to as a driver-assistance system. In the following, when there is little need to specify the achievable level of automated driving especially, the automated driving system or the driver-assistance system may be simply referred to as the driving system 2.

### Driving System Overview

An architecture of the driving system 2 is selected such that an efficient safety of the intended functionality (SOTIF) process can be realized. For example, the architecture of the driving system 2 may be configured based on a sense-plan-act model. The sense-plan-act model includes a sense element, a plan element, and an act element, as main system elements. The sense element, the plan element, and the act element interact with each other. The sense may be replaced with perception, the plan may be replaced with judgement, and the act may be replaced with control, respectively.

In such a driving system 2, at a functional level (in other words, from a functional perspective), a sensing function, a planning function, and an acting function are implemented. At a technical level (in other words, a technical perspective), at least multiple sensors corresponding to the sensing function, at least one processing system corresponding to the planning function, and multiple motion actuators 60 corresponding to the acting function are implemented.

Specifically, a sensing unit 10 as a functional block for realizing the sensing function mainly using the multiple sensors, a processing system that processes sense information of the multiple sensors, and a processing system that generates an environment model based on information of the multiple sensors may be constructed in the driving system 2. A planning unit 20 and an RSS 26 as functional blocks that realize the planning function mainly using a processing system 50 may be constructed in the driving system 2. An acting unit 30 as a functional block for realizing the acting function mainly using multiple motion actuators 60 and at least one processing system that outputs an operation signal of the multiple motion actuators 60 may be constructed in the driving system 2.

The sensing unit 10 may be realized in a form of a sensing system serving as a subsystem that is provided to be distinguishable from the planning unit 20 and the acting unit 30. The planning unit 20 may be realized in a form of a planning system as a subsystem provided to be distinguishable from the sensing unit 10 and the acting unit 30. The planning system may also include the RSS 26. The acting unit 30 may be realized in a form of an acting system serving as a subsystem that is provided to be distinguishable from the sensing unit 10 and the planning unit 20. The sensing system, the planning system and the acting system may constitute independent components. The system here may be replaced with a module, a unit, a device, or the like.

Further, multiple human machine interface (HMI) devices 70 may be mounted in the vehicle 1. The HMI device 70 realizes a human machine interaction, which is an interaction between an occupant (including a driver) of the vehicle 1 and the driving system 2. Some of the multiple HMI devices 70, which realize an operation input function for the occupant, may be a part of the sensing unit 10. Some of the multiple HMI devices 70, which realize an information presentation function, may be a part of the acting unit 30. Meanwhile, the function realized by the HMI device 70 may be provided as a function independent of the sensing function, the planning function, and the acting function.

The sensing unit 10 serves as the sensing function including localization (for example, estimation of position) of a road user such as the vehicle 1 and another vehicle. The sensing unit 10 senses an external environment, an internal environment, and a vehicle state of the vehicle 1 and further, a state of the driving system 2. The sensing unit 10 fuses the sensed information to generate an environment model. The environment model may be referred to as a world model. The planning unit 20 applies a purpose and a driving policy to the environment model generated by the sensing unit 10 to derive a control act. The acting unit 30 executes the control act derived by the planning unit 20.

### Physical Architecture Overview

An example of a physical architecture of the driving system 2 will be described by using FIG. 2. The driving system 2 includes the multiple sensors, the multiple motion actuators 60, the multiple HMI devices 70, at least one processing system 50, and the like. These elements can communicate with each other through one or both of a wireless connection and a wired connection. These elements may be capable of communicating with each other through, for example, an in-vehicle network such as a CAN (registered trademark). These elements are described in more detail with reference to FIG. 2.

The multiple sensors include one or multiple external environment sensors 41. The multiple sensors may include at least one type among one or multiple internal environment sensors 42, one or multiple communication systems 43, and a map database (DB) 44.

The external environment sensor 41 may detect a target object present in the external environment of the vehicle 1. Examples of the external environment sensor 41 having a target object detection type include, for example, a camera, a light detection and ranging/laser imaging detection and ranging (LiDAR) laser radar, a millimeter wave radar, an ultrasonic sonar, and the like. Typically, a combination of multiple types of external environment sensors 41 may be mounted to monitor each direction of a front direction, a side direction, and a rear direction of the vehicle 1.

As an example of mounting the external environment sensor 41, the ego-vehicle 1 may be mounted with multiple cameras (for example, 11 cameras) configured to respectively monitor each direction of the front direction, the front side direction, the side direction, and the rear side direction, the rear direction of the vehicle 1.

As another mounting example, multiple cameras (for example, four cameras) configured to monitor each of a front, a side, and a rear of the vehicle 1, multiple millimeter wave radars (for example, five millimeter wave radars) configured to monitor each of the front, the front side, the side, and the rear of the vehicle 1, and the LiDAR configured to monitor the front of the vehicle 1 may be mounted in the vehicle 1.

Further, the external environment sensor 41 may detect a state of an atmosphere or a state of a weather, in the external environment of the vehicle 1. The external environment sensor 41 having a state detection type is, for example, an outside air temperature sensor, a temperature sensor, a raindrop sensor, or the like.

The internal environment sensor 42 may detect a specific physical quantity (hereinafter, a motion physical quantity) related to a vehicle motion in the internal environment of the vehicle 1. Examples of the internal environment sensor 42 having a motion physical quantity detection type include a speed sensor, an acceleration sensor, a gyro sensor, and the like. The internal environment sensor 42 may detect a state of an occupant in the internal environment of the vehicle 1. The internal environment sensor 42 having an occupant detection type is, for example, an actuator sensor, a driver monitoring sensor and a system thereof, a biometric sensor, a seating sensor, an in-vehicle device sensor, or the like. In particular, examples of the actuator sensor include an accelerator sensor, a brake sensor, a steering sensor, and the like that detect an operation state of the occupant with respect to the motion actuator 60 related to motion control of the vehicle 1.

The communication system 43 acquires communication data usable in the driving system 2 through wireless communication. The communication system 43 may receive a positioning signal from an artificial satellite of a global navigation satellite system (GNSS) present in the external environment of the vehicle 1. A communication device having a positioning type in the communication system 43 is, for example, a GNSS receiver or the like.

The communication system 43 may transmit and receive a communication signal to and from an external system 96 present in the external environment of the vehicle 1. A communication device having a V2X type in the communication system 43 is, for example, a dedicated short range communications (DSRC) communication device, a cellular V2X (C-V2X) communication device, or the like. Examples of the communication with the V2X system present in the external environment of the vehicle 1 include communication with a communication system of another vehicle (V2V), communication with infrastructure such as a communication device set in a traffic light or a roadside device (V2I), communication with a mobile terminal of a pedestrian (V2P), communication with a network such as a cloud server (V2N), and the like. An architecture of V2X communication, including V2I communication, may adopt an architecture defined in ISO21217, ETSI TS 102 940-943, IEEE 1609, or the like.

Further, the communication system 43 may transmit and receive a communication signal to and from the internal environment of the vehicle 1, for example, with a mobile terminal 91 such as a smartphone present in the vehicle. A communication device having a terminal communication type in the communication system 43 is, for example, a Bluetooth (registered trademark) device, a Wi-Fi (registered trademark) device, an infrared communication device, or the like.

The map DB 44 is a database that stores map data that can be used in the driving system 2. The map DB 44 is configured with at least one type of non-transitory tangible storage medium of, for example, a semiconductor memory, a magnetic medium, an optical medium, and the like. The map DB 44 may include a database of a navigation unit that navigates a travel route of the vehicle 1 to a destination. The map DB 44 may include a database of a probe data (PD) map generated by using PD collected from each vehicle. The map DB 44 may include a database of a high definition map having a high level of definition mainly used for an automated driving system. The map DB 44 may include a database of a parking lot map including specific parking lot information, for example, parking frame information, used for automated parking or parking support.

The map DB 44 appropriate to the driving system 2 acquires and stores the latest map data through, for example, communication with a map server via the communication system 43 having a V2X type. The map data is converted into two-dimensional or three-dimensional data as data indicating the external environment of the vehicle 1. The map data may include, for example, road data representing at least one type among positional coordinates of a road structure, a shape, a road surface condition, and a standard roadway. The map data may include marking data representing at least one type of, for example, a traffic sign, a road display, a positional coordinate and a shape of a lane marking, and the like attached to a road. The marking data included in the map data may represent, for example, a traffic sign, an arrow marking, a lane marking, a stop line, a direction sign, a landmark beacon, a business sign, and a change in a line pattern of a road, among target objects. The map data may include structure data representing at least one type of positional coordinates, a shape, and the like of a building and a traffic light facing the road, for example. The marking data included in the map data may represent, for example, a streetlight, a road edge, a reflecting plate, a pole, and the like, among the target objects.

The motion actuator 60 is capable of controlling a vehicle motion based on an input control signal. The motion actuator 60 having a driving type is a power train including, for example, at least one type among an internal combustion engine, a drive motor, and the like. The motion actuator 60 having a braking type is, for example, a brake actuator. The motion actuator 60 having a steering type is, for example, a steering.

The HMI device 70 may be an operation input device capable of inputting an operation by a driver to transmit to the driving system 2, the will or intention of the occupant of the vehicle 1 including the driver. The HMI device 70 having an operation input type is, for example, an accelerator pedal, a brake pedal, a shift lever, a steering wheel, a turn signal lever, a mechanical switch, a touch panel such as a navigation unit, or the like. Among those, the accelerator pedal controls the power train serving as the motion actuator 60. The brake pedal controls the brake actuator serving as the motion actuator 60. The steering wheel controls a steering actuator as the motion actuator 60.

The HMI device 70 may be an information presentation device that presents information such as visual information, auditory information, cutaneous sensation information, and the like to the occupant of the vehicle 1 including the driver. The HMI device 70 having a visual information presentation type is, for example, a combination meter, a graphic meter, the navigation unit, a center information display (CID), a head-up display (HUD), an illumination unit, or the like. The HMI device 70 having an auditory information presentation type is, for example, a speaker, a buzzer, or the like. The HMI device 70 having a cutaneous information presentation type is, for example, a vibration unit of the steering wheel, a vibration unit of a seat of the driver, a reaction force unit of the steering wheel, a reaction force unit of the accelerator pedal, a reaction force unit of the brake pedal, an air conditioning unit, or the like.

The HMI device 70 may realize an HMI function in cooperation with a mobile terminal 91 such as a smartphone by communicating with the terminal through the communication system 43. For example, the HMI device 70 may present information acquired from the smartphone to the occupant including the driver. For example, an operation input of the smartphone may be used as an alternative to an operation input to the HMI device 70.

At least one processing system 50 is provided. For example, the processing system 50 may be an integrative processing system that executes a process related to the sensing function, a process related to the planning function, and a process related to the acting function in an integrated manner. In this case, the integrative processing system 50 may further execute a process related to the HMI device 70, and an HMI dedicated processing system may be separately provided. For example, the HMI dedicated processing system may be an integrated cockpit system that integrally executes a process related to each HMI device 70.

For example, the processing system 50 may be configured to include each of at least one processing unit corresponding to the process related to the sensing function, at least one processing unit corresponding to the process related to the planning function, and at least one processing unit corresponding to the process related to the acting function.

The processing system 50 includes a communication interface for an outside, and is connected to at least one type of elements related to the process performed by the processing system 50 among each sensor, the motion actuator 60, the HMI device 70, and the like via at least one type among, for example, a local area network (LAN), a wire harness, an internal bus, and a wireless communication circuit.

The processing system 50 is configured to include at least one dedicated computer 51. The processing system 50 may combine multiple dedicated computers 51 to realize a function such as the sensing function, the planning function, and the acting function.

For example, the dedicated computer 51 constituting the processing system 50 may be an integrated ECU that integrates a driving function of the vehicle 1. The dedicated computer 51 constituting the processing system 50 may be a determination ECU that determines a DDT. The dedicated computer 51 constituting the processing system 50 may be a monitoring ECU that monitors driving of the vehicle. The dedicated computer 51 constituting the processing system 50 may be an evaluation ECU that evaluates driving of the vehicle. The dedicated computer 51 constituting the processing system 50 may be a navigation ECU that navigates a travel route of the vehicle 1.

The dedicated computer 51 constituting the processing system 50 may be a locator ECU that estimates a position of the vehicle 1. The dedicated computer 51 constituting the processing system 50 may be an image processing ECU that processes image data detected by the external environment sensor 41. The dedicated computer 51 constituting the processing system 50 may be an actuator ECU that controls the motion actuator 60 of the vehicle 1. The dedicated computer 51 constituting the processing system 50 may be an HMI control unit (HCU) that integrally controls the HMI devices 70. The dedicated computer 51 constituting the processing system 50 may be at least one external computer that constructs an external center or a mobile terminal 91 that enables communication via the communication system 43, for example.

The dedicated computer 51 constituting the processing system 50 includes at least one memory 51a and at least one processor 51b. The memory 51a may be, for example, at least one type of non-transitory tangible storage medium, such as a semiconductor memory, a magnetic medium, an optical medium, and the like, which non-temporarily stores a program, data, and the like that can be read by the processor 51b. Further, for example, a rewritable volatile storage medium such as a random access memory (RAM) may be provided as the memory 51a. The processor 51b includes, for example, at least one type of a central processing unit (CPU), a graphics processing unit (GPU), and a reduced instruction set computer (RISC)-CPU as a core.

The dedicated computer 51 constituting the processing system 50 may be a system on a chip (SoC) in which a memory, a processor, and an interface are integrally realized on one chip, or the SoC may be provided as an element of the dedicated computer 51.

The processing system 50 may include at least one database for executing a dynamic driving task. The database may include, for example, a non-transitory tangible storage medium of at least one type of a semiconductor memory, a magnetic medium, and an optical medium, and an interface for accessing the storage medium.

The database may be a scenario database (hereinafter, referred to as “scenario DB”) 59. The database may be a rule database (hereinafter, rule DB) 58. At least one of the scenario DB 59 and the rule DB 58 may not be provided in the processing system 50, but may be provided independently in the driving system 2. At least one of the scenario DB 59 and the rule DB 58 may be provided in the external system 96 and configured to be accessible from the processing system 50 via the communication system 43.

The scenario DB 59 has a scenario catalog in which multiple scenarios used for driving the vehicle 1 are stored. The driving system 2 can, for example, apply the situation in which the vehicle 1 is located to one scenario selected from multiple scenarios or a combination of multiple scenarios. The scenario DB 59 may store multiple scenarios including at least one of a functional scenario, a logical scenario, and a concrete scenario. The functional scenario defines a top-level qualitative scenario structure. The logical scenario is a scenario obtained by assigning a quantitative parameter range to a structured functional scenario. The concrete scenario defines a boundary of a safety determination for distinguishing between a safe state and an unsafe state.

The rule DB 58 stores a rule set used for driving the vehicle 1. The rule set may include multiple rules. The rule set may further include a structure of the degree of priority for a series of rules, which is established based on a relative importance among the multiple rules. The rule set may be an implementation of guidelines for strategic driving of the vehicle 1.

The multiple rules may include rules based on laws, regulations, and a combination thereof. The multiple rules may include rules based on a preference that is not influenced by the laws, the regulations, or the like. The multiple rules may include rules based on a motion behavior based on an experience in the past. The multiple rules may include rules based on a characterization of a motion environment. The multiple rules may include rules based on ethical concerns. The multiple rules may include rules based on a basic principle of a safety model to be described below (for example, the five principles of an RSS model).

The processing system 50 may also include at least one recording device 55 that records at least one of the sense information, plan information, and act information of the driving system 2. The recording device 55 may include at least one large capacity storage medium 55c. The storage medium 55c may be at least one type of non-transitory tangible storage medium among, for example, a semiconductor memory, a magnetic medium, and an optical medium.

The storage medium 55c may be mounted on a substrate in a form that is not easily detachable or replaceable, and in this form, for example, an embedded multimedia card (eMMC) or the like using a flash memory may be adopted. At least one of the storage media 55c may be in a form that is detachable and replaceable with respect to the recording device 55, and in this form, for example, an SD card or the like may be adopted.

The recording device 55 may have a function of selecting information to be recorded from among the sense information, the plan information, and the act information. In this case, the recording device 55 may include a dedicated computer.

The dedicated computer provided in the recording device 55 has at least one memory 55a and at least one processor 55b. The memory 55a may be, for example, at least one type of a non-transitory tangible storage medium, such as a semiconductor memory, a magnetic medium, an optical medium, and the like, which non-temporarily stores a program, data, and the like that can be read by the processor 55b. Further, for example, a rewritable volatile storage medium such as a random access memory (RAM) may be provided as the memory 55a. The processor 55b includes, for example, at least one type of a central processing unit (CPU), a graphics processing unit (GPU), and a reduced instruction set computer (RISC)-CPU as a core.

The dedicated computer may be a system on a chip (SoC) in which a memory, a processor, and an interface are integrally realized on one chip, or the SoC may be provided as an element of the dedicated computer.

The recording device 55 may access the storage medium 55c, and execute recording in accordance with a data write command from the driving system 2. The recording device 55 may determine information flowing through the in-vehicle network, access the storage medium 55c, and execute recording based on determination of the processor 55b provided in the recording device 55.

The recording device 55 may not be provided in the processing system 50 but may be provided independently in the driving system 2. The recording device 55 may be provided in the external system 96, and configured to be accessible from the processing system 50 via the communication system 43.

Further, the processing system 50 may include at least one RSS unit 53.

The RSS unit 53 may be one aspect of on-board implementation of responsibility sensitive safety (RSS) as a safety model. The RSS unit 53 may be an on-board checker for the planning function realized by the dedicated computer 51.

The RSS unit 53 may be configured mainly with a dedicated computer having at least one memory 53a and at least one processor 53b. The memory 53a may be, for example, at least one type of a non-transitory tangible storage medium, such as a semiconductor memory, a magnetic medium, an optical medium, and the like, which non-temporarily stores a program, data, and the like that can be read by the processor 53b. Further, for example, a rewritable volatile storage medium such as a random access memory (RAM) may be provided as the memory 53a. The processor 53b includes, for example, at least one type of a central processing unit (CPU), a graphics processing unit (GPU), and a reduced instruction set computer (RISC)-CPU as a core.

The dedicated computer may be a system on a chip (SoC) in which a memory, a processor, and an interface are integrally realized on one chip, or the SoC may be provided as an element of the dedicated computer.

### Logical Architecture Overview

Next, an example of a logical architecture of the driving system 2 will be described with reference to FIG. 1. The sensing unit 10 receives sensor data detected by each sensor. A reception function may be realized by a sensor data reception unit 12 which is a sub-block into which the sensing function is further classified. The sensing unit 10 individually processes the sensor data of the external environment sensor 41, and realizes an external perception function for perceiving a road sign, another road user, or the like. The sensor data may be data provided from, for example, a millimeter wave radar, a sonar, or a LIDAR. The sensing unit 10 may generate relative position data of an object, including a direction, a size, and a distance of the object with respect to the vehicle 1 from raw data detected by the external environment sensor 41.

The sensor data may be image data provided from a camera or LiDAR, for example. The sensing unit 10 processes the image data, and extracts an object that is reflected in an angle of view of a camera or the like. The extraction of the object may include estimation of the direction, the size, and the distance of the object with respect to the vehicle 1. The extraction of the object may include, for example, classification of the object by using semantic segmentation.

The sensing unit 10 executes localization of the vehicle 1. The sensing unit 10 acquires global position data of the vehicle 1 from, for example, a GNSS receiver as the communication system 43. In addition, the sensing unit 10 integrates at least one of information of the map DB 44, position information of an object perceived by using the external environment sensor 41, and position information of the object perceived as a result of sensor fusion to be described below, with the global position data to estimate a position of the vehicle 1 on a map.

The sensing unit 10 integrates the sensor data of each external environment sensor 41, localization information, and V2X information acquired through V2X communication. This enables the sensing unit 10 to specify the number of, a type of, and a relative position of other road users in the vicinity of the vehicle 1. The sensing unit 10 specifies a static structure of a road in the vicinity of the vehicle 1, based on road target object information perceived by the external environment sensor 41. The static structure of the road includes, for example, curvature of a curve, the number of lanes, and a free space.

In this manner, the sensing unit 10 generates an environment model that includes an environment of the vicinity of the vehicle 1. An environment model generation function may be realized by a model extraction unit 11 as a sub-block into which the sensing function is further classified. The environment model can be provided to the planning unit 20 and the RSS 26. The environment model may be an external environment model specialized for an external environment.

The sensing unit 10 may have a function of processing sensor data detected by each internal environment sensor 42, and perceiving a vehicle state. The vehicle state may include a state of a motion physical quantity of the vehicle 1 detected by a speed sensor, an acceleration sensor, a gyro sensor, or the like. The vehicle state may include at least one type of a state of an occupant including a driver, a state of the motion actuator 60, an operation state of the driver with respect to the motion actuator 60, and a state of the HMI devices 70. The environment model may be a comprehensive model obtained by fusing information on the internal environment, the vehicle state, the state of the driving system 2, and the like, in addition to the external environment.

The planning unit 20 acquires the environment model generated by the sensing unit 10, the vehicle state, or the like, and executes determination on the environment based on these. Specifically, the planning unit 20 may estimate a situation in which the vehicle 1 is currently located by interpreting the environment model. The situation here may be an operational situation. The planning unit 20 may predict an act of the other road user by interpreting the environment model. The planning unit 20 may interpret the environment model, and predict a trajectory of the other road user object. The planning unit 20 may also interpret an environment model, and predict a potential hazard.

The planning unit 20 may also interpret the environment model, and execute determination as to a scenario in which the vehicle 1 is currently located. The determination as to the scenario may be selection of at least one scenario in which the vehicle 1 is currently located, from a catalog of scenarios constructed in the scenario DB 59.

Further, the planning unit 20 may estimate an intention of a driver, based on at least one of the predicted act, the predicted object trajectory, the predicted potential hazard, and the determination on the scenario, as well as the vehicle state including an operation state of the HMI device 70.

The planning unit 20 plans driving of the vehicle 1, based on at least one of estimation information of a position of the vehicle 1 on a map, the determination on the environment, intention estimation of the driver, and a functional restriction.

The planning unit 20 realizes a route planning function, a behavior planning function, and a trajectory planning function. The route planning function is a function of planning at least one of a route to a destination and a lane plan at a middle distance based on the estimation information of the position of the vehicle 1 on the map. The route planning function may further include a function of determining at least one request of a lane changing request and a deceleration request, based on the lane plan at the middle distance. The route planning function may be a mission and route planning function in a strategic function, or may be a function of outputting a mission plan and a route plan.

The behavior planning function is a function of planning a behavior of the vehicle 1, based on at least one of a route to a destination planned by the route planning function, the lane plan at the middle distance, the lane changing request, the deceleration request, the determination on the environment, the intention estimation of the driver, and the functional restriction. The behavior planning function may include a function of generating a condition related to a state transition of the vehicle 1. The condition related to the state transition of the vehicle 1 may correspond to a triggering condition. The behavior planning function may include a function of determining a state transition of an application that realizes a DDT, and further include a function of determining a state transition of a driving act, based on the condition. The behavior planning function may include a function of determining a restriction related to a path of the vehicle 1 in a longitudinal direction and a restriction related to the path of the vehicle 1 in a lateral direction, based on information on these state transitions. The behavior planning function may be a strategic behavior plan in a DDT function, or may output strategic behavior.

The trajectory planning function is a function of planning a traveling trajectory of the vehicle 1, based on the determination on the environment, the restriction related to the path of the vehicle 1 in the longitudinal direction, and the restriction related to the path of the vehicle 1 in the lateral direction. The trajectory planning function may include a function of generating a path plan. The path plan may include a velocity plan, or the velocity plan may be generated as a plan independent of the path plan. The trajectory planning function may include a function of generating multiple path plans and selecting an optimal path plan from the multiple path plans, or a function of switching between the path plans. The trajectory planning function may further include a function of generating backup data of the generated path plan. The trajectory planning function may be a trajectory planning function in the DDT function, or may output a trajectory plan.

Further, the planning unit 20 may manage a mode of the driving system 2 or a mode of automated driving. The management of the mode of the automated driving may include, for example, management of a state of an automated driving level. The management of the automated driving level may include switching between manual driving and automated driving, that is, permission transfer between the driver and the driving system 2, in other words, management of takeover. The planning unit 20 may monitor a state of each subsystem in the driving system 2, and determine a defect of the system (for example, an error, an unstable operation state, a system failure, or a failure).

The planning unit 20 may determine the mode based on an intention of a driver, based on intention estimation of the driver. The planning unit 20 may set a restriction on a function related to driving, based on at least one of a sensor abnormality (or sensor failure) signal output from each sensor, state transition information of an application, and a trajectory plan.

The planning unit 20 may have a function of determining the restriction related to the path of the vehicle 1 in the longitudinal direction and the restriction related to the path of the vehicle 1 in the lateral direction, in addition to the functional restriction related to driving. In this case, as described above, the planning unit 20 plans a behavior and plans a trajectory according to this restriction.

The acting unit 30 acquires the trajectory plan (for example, path plan and velocity plan) from the planning unit 20. Further, the acting unit 30 acquires information on a proper response from the RSS 26. The information on the proper response may be a request for the acting unit 30 to execute the proper response. The request to execute the proper response may be a restriction request.

When there is no request from the RSS 26, the acting unit 30 controls a motion of the vehicle 1, based on the trajectory plan by the planning unit 20. The acting unit 30 generates accelerator request information, shift request information, brake request information, and steering request information corresponding to the trajectory plan, and outputs the accelerator request information, the shift request information, the brake request information, and the steering request information to the motion actuator 60.

The acting unit 30 applies the proper response to the trajectory plan when requested by the RSS 26. The application of the proper response may be to apply a restriction requested from the RSS to the trajectory plan. A function of applying the RSS restriction may be realized by an RSS restriction application unit 31, which is a sub-block into which the acting function is further classified. The acting unit 30 generates accelerator request information, shift request information, brake request information, and steering request information corresponding to a plan after the application of the request from the RSS 26, and outputs the accelerator request information, the shift request information, the brake request information, and the steering request information to the motion actuator 60. A function of generating such a request to the motion actuator 60 may be realized by an actuator request generation unit 32 as a sub-block into which the acting function is further classified.

The acting unit 30 may have a function of directly acquiring a vehicle state perceived by the sensing unit 10, for example, at least one of the current velocity, an acceleration, and a yaw rate of the vehicle 1, from the sensing unit 10, and reflecting the vehicle state in the motion control of the vehicle 1.

Further, the acting unit 30 may include an HMI output unit 33 as a sub-block into which the acting function is further classified. The HMI output unit 33 may be configured independent of the acting unit 30 in terms of either or both of hardware and software.

The HMI output unit 33 may output information to an occupant of the vehicle 1, including a driver, based on at least one of information on determination on the environment, estimation of the intention of the driver, a state transition of the application, the trajectory plan, the functional restriction, and the proper responses by the RSS 26. The HMI output unit 33 may manage a vehicle interaction. The HMI output unit 33 may generate a notification request based on a management state of the vehicle interaction, and control an information presentation function of the HMI devices 70. Further, the HMI output unit 33 may generate a control request for a wiper, a sensor cleaning device, a headlight, and an air conditioner mounted in the vehicle 1, and control these devices.

### Safety Model and Its Implementation

The driving system 2 may implement a safety model of automated driving. The safety model is a model for demonstrating the absence of an unallowable risk within a specific operational design domain (ODD). The safety model may correspond to, for example, a safety driving model, a safety-related model, or a formal model. As the safety model, for example, the RSS model may be adopted. Meanwhile another model, a more generalized model, or a complex model obtained by combining multiple models may also be adopted.

For example, in the RSS model, five rules (five principles) are adopted. The first rule is “Do not hit someone from behind”. The second rule is “Do not cut-in recklessly”. The third rule is “Right-of-way is given, not taken”. The fourth rule is, “Be careful of area another one, you must do it”. The fifth rule is “If you can avoid an accident without causing another one, you must do it”.

Based on the five rules, particularly the first and second rules, a safety envelope may be defined. For example, the safety envelope may mean a longitudinal safety distance and a lateral safety distance with respect to the other road user or may mean a condition or a concept for calculating these safety distances. The safety distance is an example of a geometric approach.

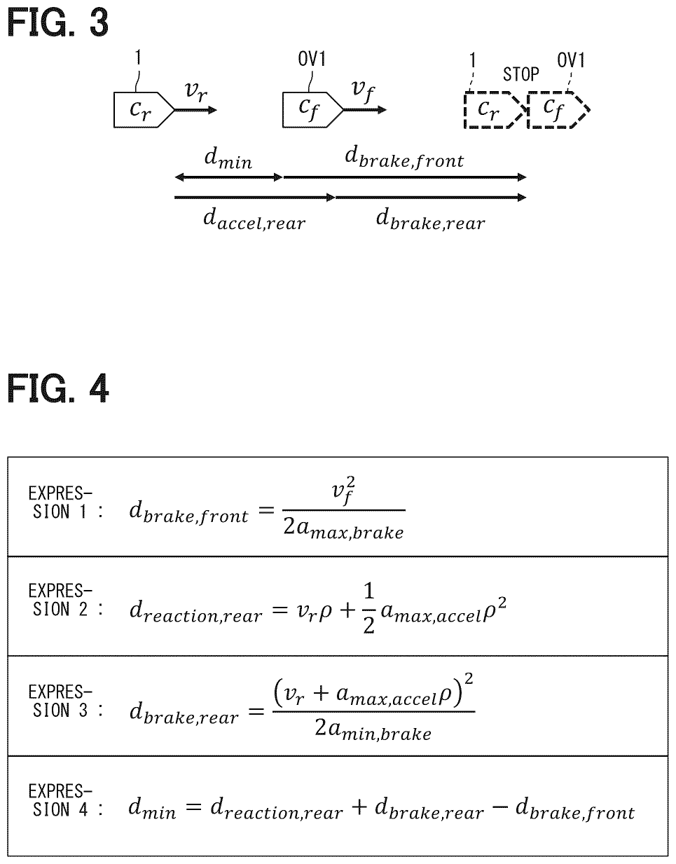

A longitudinal safety distance dₘᵢₙ may be a distance at which a rear-end collision does not occur when a preceding vehicle OV1, traveling at a velocity v_{f}, brakes at a maximum deceleration a_{max,brake} and stops, even when a following vehicle (for example, vehicle 1) accelerates with a response time p and a maximum acceleration a_{max, accel}, and then brakes at a minimum deceleration a_{min,brake} and stops, as illustrated in FIG. 3.

d_{brake,front} indicated in Expressions 1 and 4 in FIG. 4 is a stop distance of the preceding vehicle OV1. d_{reaction} indicated in Expressions 2 and 4 in FIG. 4 is a free traveling distance of the following vehicle. d_{brake,rear} indicated in Expressions 3 and 4 in FIG. 4 is a braking distance of the following vehicle. As indicated in Expression 4 in FIG. 4, the safety distance dₘᵢₙ may be a distance of a stop distance of the preceding vehicle OV1 plus the free traveling distance of the following vehicle minus the braking distance of the following vehicle.

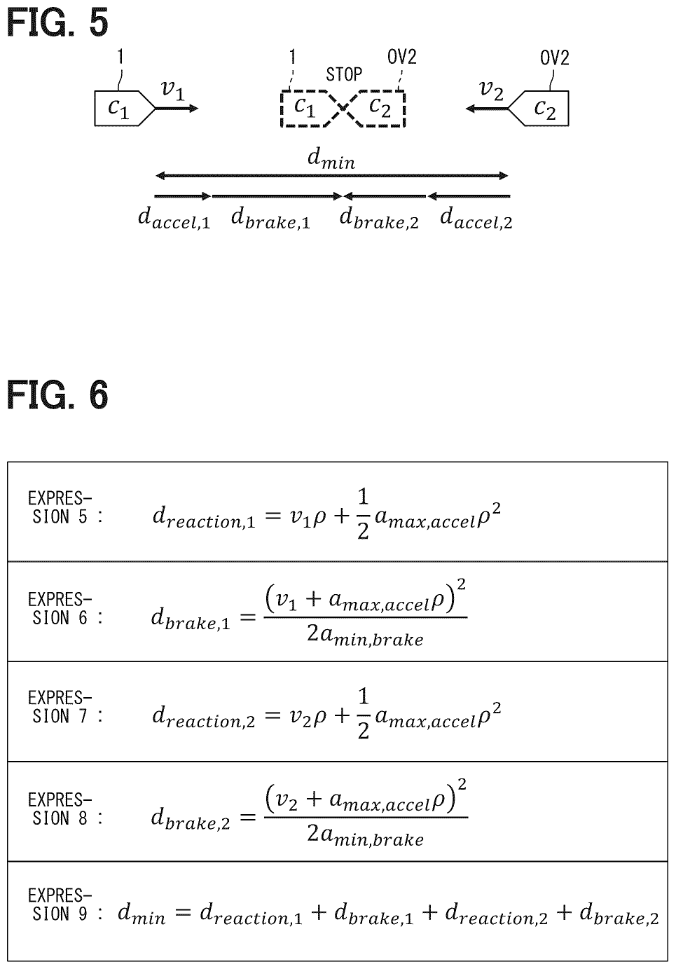

The longitudinal safety distance dₘᵢₙ may be a distance at which a head-on collision does not occur even when two vehicles 1 and OV2 are traveling toward each other at their respective velocities v₁ and v₂, accelerate with the predetermined response time p and the maximum acceleration a_{max,accel}, and then brake and stop at the minimum deceleration a_{min,brake}, as illustrated in FIG. 5.

d_{reaction,1} indicated in Expression 5 in FIG. 6 is a free traveling of the vehicle 1. d_{brake,1} indicated in Expression 6 in FIG. 6 is a braking distance of the vehicle 1. d_{reaction,2} indicated in Expression 7 in FIG. 6 is a free traveling distance of the vehicle OV2. d_{brake,2} indicated in Expression 8 in FIG. 6 is a braking distance of the vehicle OV2. As indicated in Expression 9 in FIG. 6, the safety distance dₘᵢₙ may be a sum of the free traveling distance of the vehicle 1, the braking distance of the vehicle 1, a free traveling distance of the vehicle OV2, and the braking distance of the vehicle OV2.

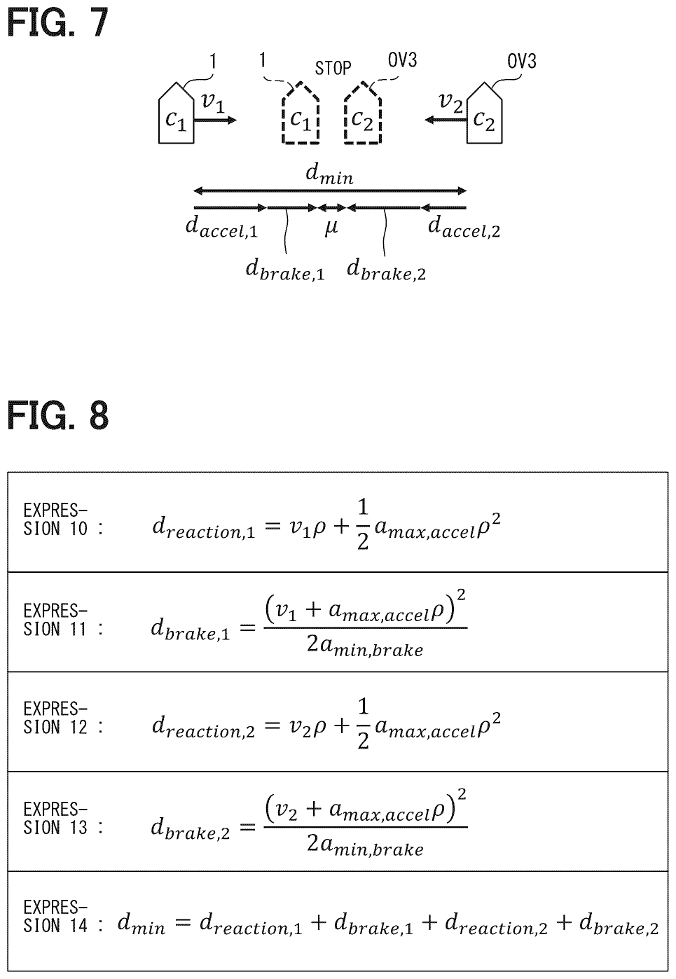

The lateral safety distance dₘᵢₙ may be a distance at which a minimum distance μ is secured and a collision does not occur even when two vehicles 1 and OV3 are traveling side by side at the lateral velocities v₁ and v₂, respectively, accelerate at the predetermined response time p and the maximum acceleration a_{max,accel}, and then decelerate in the lateral direction at the maximum deceleration a_{min,brake}, as illustrated in FIG. 7.

d_{reaction,1} indicated in Expression 10 in FIG. 8 is a free traveling distance of the vehicle 1. d_{brake,1} indicated in Expression 11 in FIG. 8 is a braking distance of the vehicle 1. d_{reaction,2} indicated in Expression 12 in FIG. 8 is a free traveling distance of the vehicle OV3. d_{brake,2} indicated in Expression 13 in FIG. 8 is a braking distance of the vehicle OV3. As illustrated in Expression 14 in FIG. 8, the safety distance dₘᵢₙ may be a sum of the free traveling distance of the vehicle 1, the braking distance of the vehicle 1, a free traveling distance of the vehicle OV3, and the braking distance of the vehicle OV3.

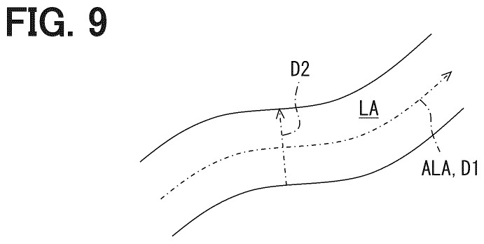

A coordinate system used in the safety model may be a lane-based coordinate system. As illustrated in FIG. 9, this coordinate system processes movement of the vehicle 1 in a direction along a lane LA by defining a center line of the lane LA, that is, a lane axis ALA along a curve of a road. On the other hand, in order to define a longitudinal axis and a lateral axis of each road user, a road-user-based coordinate system may be used. This coordinate system is based on a center of gravity of the road user and defines an ordinate and an abscissa depending on a heading angle of the road user.

The RSS 26 implemented in the driving system 2 is disposed in parallel with the planning unit 20 in terms of architecture, for example, and executes a calculation process. Specifically, the RSS 26 acquires an environment model, sensor data, or the like from the sensing unit 10, evaluates a risk based on this information, and outputs a response according to the risk to the acting unit 30. As illustrated in FIG. 1, the RSS 26 may include a situation extraction unit 27, a situation checking unit 28, and a response unit 29 as sub-blocks into which its function is further classified.

The situation extraction unit 27 extracts a situation based on information acquired from the sensing unit 10. Data indicating the situation (hereinafter, situation data) may include a list of objects present in the vicinity of the vehicle 1 (hereinafter, surrounding objects). The surrounding object may include another road user. The situation data may include data indicative of a potential conflict between the vehicle 1 and the surrounding object. In this case, the situation data may include a probability of the presence, and an uncertainty of a position, an orientation, and a velocity of the vehicle 1 and the surrounding object. The situation extraction unit 27 may extract multiple situations. The situation may be a traffic situation. The situation may be selected from a set of considered situations.

The situation checking unit 28 checks whether the situation extracted by the situation extraction unit 27 is a safe situation or a hazardous situation. The situation checking unit 28 executes at least one of checking by the geometric approach described above and checking a risk by using another methodology. When the risk check is executed, a safety envelope may refer to an allowable collision risk.

The risk check may include a check of an estimated result of the collision risk between the vehicle 1 and the surrounding object. The collision risk may include a collision risk over time, and may include a peak collision risk. The collision risk may be a probability of collision. That is, an uncertainty can be taken into account in the risk check.

When the safety envelope is violated, the situation checking unit 28 determines that a situation as a check target is a hazardous situation. When the situation checking unit 28 executes the risk check, the situation checking unit 28 may compare the estimated collision risk value with a threshold value of an allowable collision risk. When the estimated collision risk value is below the threshold value of the allowable collision risk, the situation checking unit 28 may determine that the situation as a check target is a safe situation. When the estimated collision risk value exceeds the threshold value of the allowable collision risk, the situation checking unit 28 may determine that the situation as a check target is a hazardous situation. That is, when there is no violation of the safety envelope, the situation checking unit 28 determines that the situation as a check target is a safe situation. This risk threshold value may be, for example, a longitudinal safety distance and a lateral safety distance.

The situation checking unit 28 may set a hypothesis on the surrounding object, and check a risk based on the hypothesis. In this case, multiple hypotheses may be used. The hypothesis may be or may include an assumption on a reasonably foreseeable behavior. The hypothesis may be a prediction derived based on this assumption, and may include the prediction derived based on this assumption.

That is, there is a possibility that an assumed kinematic value is influenced by an allowable risk level. The allowable risk level or the risk threshold value may be designated in advance by at least one of a government agency, a standardization agency, and an approval organization of the driving system 2. The allowable risk level or the risk threshold value may be set in advance by a developer of the driving system 2.

The situation checking unit 28 may refer to a rule set stored in the rule DB 58 to determine the allowable risk level. The situation checking unit 28 may improve estimation accuracy by incorporating the rules of the rule set into an algorithm for calculating the risk value.

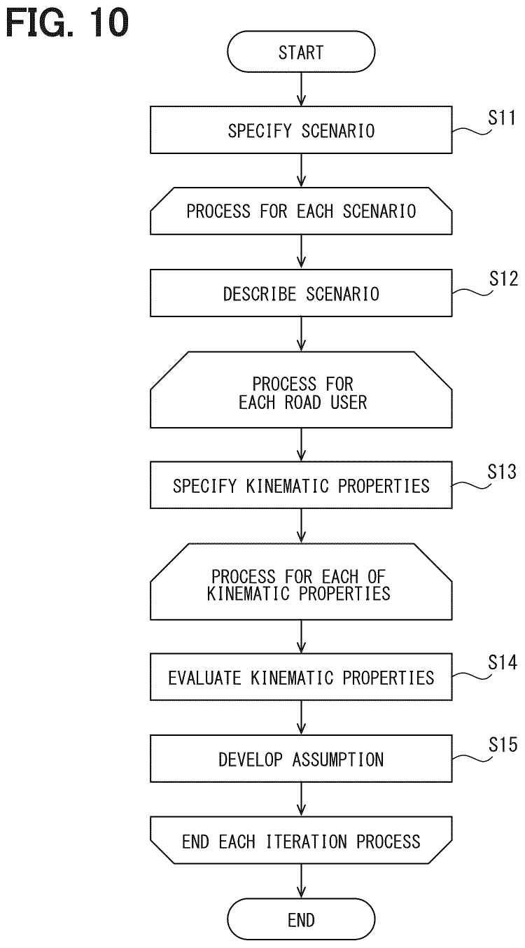

FIG. 10 illustrates an example of a processing method for deriving and defining an assumption. This process is realized, for example, by the processor 53b of the RSS unit 53 executing a program stored in the memory 53a. A series of processes in steps S11 to S15 is executed for each predetermined regular time interval or based on a predetermined trigger. The predetermined trigger may be provided as, for example, the latest situation data being provided from the situation extraction unit 27 to the situation checking unit 28.

In the first step S11, a scenario currently being encountered by the vehicle 1 is specified. The specifying of the scenario may include selecting a scenario from a catalog of a scenario stored in the scenario DB 59, for example. One scenario may be selected. Multiple scenarios may be selected. A more complex situation may be represented by combining the multiple scenarios. After the process in S11, the process proceeds to S12.

S12 to S15 are iteration processes for each scenario. In S12, a relevant scene and a road user as dynamic elements are specified and described highly. After the process in S12, the process proceeds to S13.

S13 to S15 are iteration processes for each road user. In S13, kinematic properties in charge of a motion of a road user are specified. After the process in S13, the process proceeds to S14.

S14 to S15 are iteration processes for each kinematic property. In S14, whether the kinematic properties are safety relevant is evaluated based on the scenarios specified in S11. This evaluation is executed by checking whether there is a possibility that a certain property causes a motion of another road user, which is a motion for the vehicle 1. When the kinematic property is not relevant to a safety, the kinematic property is excluded from application of the scenario specified in S11. After the process in S14, the process proceeds to S15.

In S15, an assumption on a reasonably foreseeable behavior of the other road user for the scenarios specified in S11 is created. The assumption can be defined by setting a boundary line within which a behavior of the other road user may be reasonably foreseeable range, in a specific travel situation. After the process in S15, the process is returned to S12, S13, and S14 and repeated, depending on the remaining processing state of the other scenario, road user, and kinematic properties. When the process is completed for all the scenarios, the series of processes is ended.

The assumption may be a function of a time which is changed during a specified scenario. Alternatively, the assumption may not be changed during the specified scenario. A minimum set of the assumption on the other road user may be defined.

The minimum set may include one or more properties according to a scenario, among a reasonably foreseeable maximum assumed longitudinal velocity other road users could exhibit, a reasonably foreseeable maximum assumed lateral velocity other road users could exhibit, a reasonably foreseeable maximum assumed longitudinal acceleration preceding other road users of the vehicle could exhibit, a reasonably foreseeable maximum assumed lateral acceleration other road users could exhibit, a reasonably foreseeable minimum assumed longitudinal deceleration other road users traveling in an opposite direction to the vehicle or following the vehicle could exhibit, a reasonably foreseeable minimum assumed lateral deceleration other road users could exhibit, a reasonably foreseeable maximum assumed heading angle other road users could exhibit, a reasonably foreseeable maximum assumed heading angle rate change other road users could exhibit, a reasonably foreseeable maximum assumed longitudinal position fluctuation other road users could exhibit, and a reasonably foreseeable maximum assumed response time other road users could exhibit.

The values of these assumptions may differ depending on a category of the road user. For example, an assumption value may be changed depending on whether the road user is a vulnerable road user (VRU). The assumption value may be adjusted depending on at least one of various road surface conditions and weather-related environmental conditions that are reasonably expected within an operational design domain. The assumption value may also be adjusted according to at least one of a difference in road traffic law for each country and a difference in traffic habit for each region.

The response unit 29 derives a proper response, based on a check result of the situation checking unit 28. The proper response may be provided to the acting unit 30 only when the situation is determined to be a hazardous situation. The proper response may be a limiting of a control command of the motion actuator 60. The proper response may be a response to return the vehicle 1 to a safe state. Even when multiple unrelated hazardous situations are checked, the acts to be taken by the vehicle 1 need to be integrated into one act. Thus, in this case, the response unit 29 resolves a potential conflict between the proper responses for these situations, and transmits the proper response to the acting unit 30.

Further, the RSS 26 may sequentially store at least one of data indicating the situation, the result of checking the situation, and the derived proper response in the storage medium 55c, by using the recording device 55 or the like. The RSS 26 may transmit at least one of the data indicating the situation, the result of checking the situation, and the derived proper response to the external system 96, by using the communication system 43, and accumulate the at least one in a storage medium 96a of the external system 96.

Further, the RSS 26 may execute an output in a prioritized manner to maintain duty of care for other road users. The RSS 26 may also assist an emergency maneuver. The emergency maneuver may be a minimal risk maneuver (MRM) or a DDT fallback. The emergency maneuver may be executed when the proper response to a potentially hazardous situation does not sufficiently reduce the risk when the hazardous situation actually occurs.

Further, the RSS 26 may distinguish between an initiator of a hazardous scenario and a responder of a hazardous scenario. The RSS 26 may distinguish between an act recommended for the initiator and an act recommended for the responder. That is, when vehicle 1 is the initiator, the RSS 26 derives a proper response according to the act recommended for the initiator, and when vehicle 1 is the responder, the RSS 26 derives a proper response according to the act recommended for the responder.

### Response to Passing-Through Moving Object

The RSS 26 may support a response to a passing-through moving object. Typically, a (four-wheeled) automobile (including so-called a passenger vehicle) occupies roughly one lane per width with one automobile. In contrast, the passing-through moving object may be an object that is narrower in width in the lateral direction as compared with the automobile, and can pass through the automobile in the same lane as the automobile.

Specifically, the passing-through moving object is, for example, a motorcycle (car), a bicycle, a small (autonomous) guided vehicle, or a human. The human is, for example, a pedestrian, a runner, or a scooter rider. That is, the passing-through moving object may correspond to a passing-through vehicle. The passing-through moving object may correspond to a VRU.

There are several scenarios in which a response to the passing-through moving object is to be considered. These scenarios may be stored in the scenario DB 59, and may be candidates for selection when the RSS 26 specifies a scenario.

The scenario in which a response to the passing-through moving object is to be considered may include a scenario on an automobile road including an expressway, and may also include a scenario on a general road. The scenario in which a response to the passing-through moving object may include a scenario in which there is traffic congestion and a scenario in which there is no traffic congestion. Typically, passing-through of the VRU during the traffic congestion is likely to occur. Therefore, during the traffic congestion, a motorcycle may be considered to be the passing-through moving object. On the other hand, when there is no traffic congestion, whether the VRU is the passing-through moving object may be determined depending on a situation. During no traffic congestion, when the motorcycle is traveling in a center of a lane, there is a possibility that the motorcycle is not the passing-through moving object. During no traffic congestion, there is a possibility that a bicycle is the passing-through moving object.

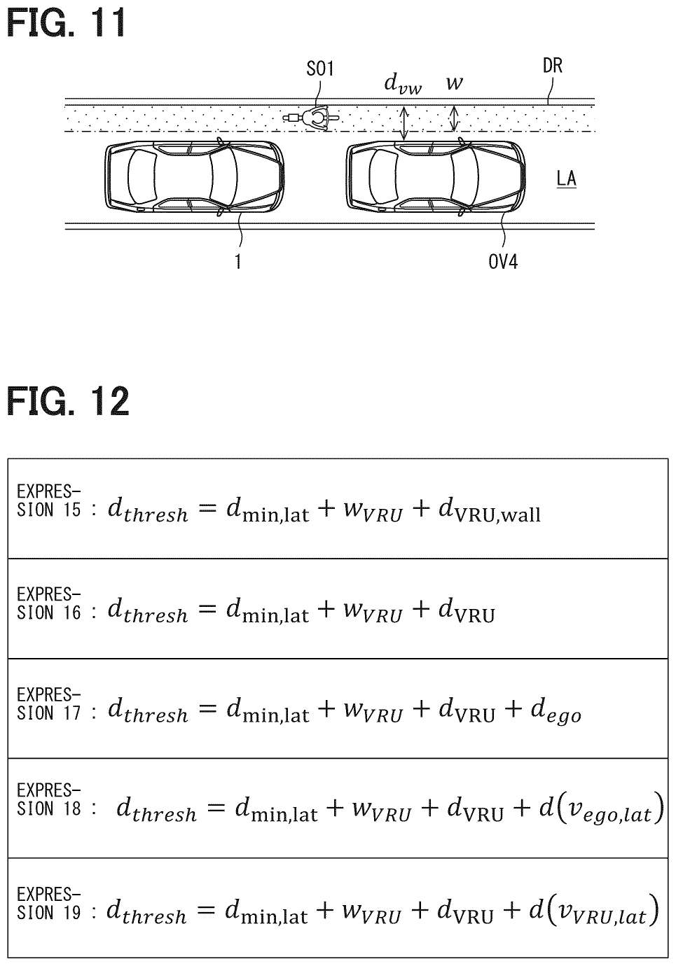

In the example illustrated in FIG. 11, the vehicle 1 is traveling behind a preceding vehicle OV4 on the same lane LA. Further, in a region close to a road end in the same lane LA, a motorcycle SO1 is traveling in the same direction as the vehicle 1 and the preceding vehicle OV4. In this scenario, the motorcycle SO1 corresponds to a passing-through moving object, and also corresponds to a VRU.

In this scenario, a dynamic element is as follows. The motorcycle SO1 is moving in the longitudinal direction in front of and/or behind the vehicle 1 on the road. A vehicle (the preceding vehicle OV4) is moving in the longitudinal direction in front of and/or behind the vehicle 1 on the road. In this scenario, a scenery is provided in which there is a speed limit sign and there is no crosswalk. In this scenario, representation of the road user is that there is no collision between the vehicle 1 and other road users.

The situation checking unit 28 of the RSS 26 may set a travel route DR assumed for the motorcycle SO1. The setting of this travel route DR may be included in an assumption on a reasonably foreseeable behavior of the other road user described above, or may be executed as a pre-process for executing the assumption of the behavior. The setting of the travel route DR may or may not be included in the minimum set of assumptions described above.

The travel route DR assumed for the motorcycle SO1 may be set based on a reasonably foreseeable behavior of the motorcycle SO1. For example, a distance from the road end to the preceding vehicle OV4 in a direction perpendicular to the lane axial direction D1 along the lane axis ALA (lane width direction D2) is defined as d_{vw}. When d_{vw}>dₜₕᵣₑₛₕ is established, the situation checking unit 28 may virtually set the travel route DR having a width w. That is, when there is a space through which the motorcycle SO1 passes between the preceding vehicle OV1 and the road end, it is predicted that the motorcycle SO1 will continue traveling along a trajectory that passes through the space.

For example, dₜₕᵣₑₛₕ may be a sum of the safety distance d_{min,lat} between the vehicle 1 and the motorcycle SO1, a lateral width w_{VRU} of the motorcycle SO1, and a margin d_{VRU,wall} to be provided between the motorcycle SO1 and the road end formed in a wall surface shape, as indicated in Expression 15 in FIG. 12.

For example, dₜₕᵣₑₛₕ may be set as indicated in Expressions 16 to 19 in FIG. 12. d_{VRU} in Expressions 16 to 19 is a margin to be provided between the motorcycle SO1, which is a VRU, and the road end, and is a value that is appropriately set depending on a road shape and another environment. In Expression 17, d_{ego} is a parameter that is set according to a type of vehicle 1. For example, when the vehicle 1 is a large vehicle such as a truck, a larger value is set than when the vehicle 1 is a small vehicle. In Expression 18, d(v_{ego,lat}) is a parameter that is set according to a longitudinal velocity of the vehicle 1. In Expression 19, d(v_{VRU,lat}) is a parameter that is set according to a longitudinal velocity of the motorcycle SO1, which is the VRU.

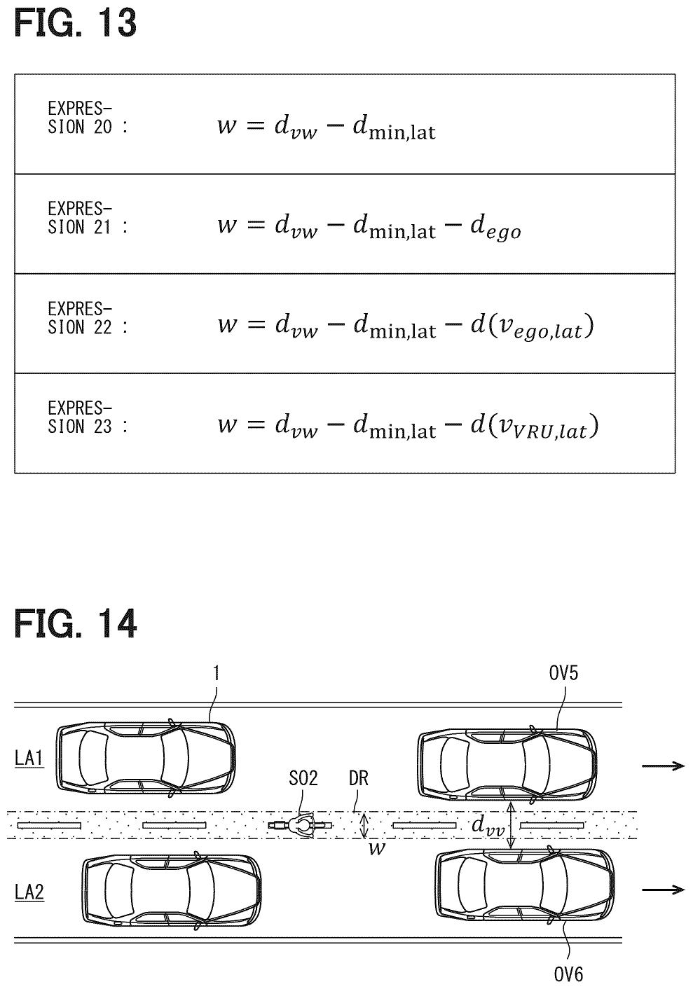

The assumed width w of the travel route DR may be calculated by subtracting d_{min,lat} from d_{vw}, as indicated in Expression 20 in FIG. 13. Expression 20 may be applied when Expressions 15 and 16 are adopted. The width w may be set as indicated in Expressions 21 to 23 in FIG. 13. Expression 21 may be applied when Expression 17 is adopted. Expression 22 may be applied when Expression 18 is adopted. Expression 23 may be applied when Expression 19 is adopted.

Further, the width w does not have to be a constant value, but may vary depending on a longitudinal position. For example, the width w of the space to the side of the vehicle 1 may be different from the width w of the space to the side of the preceding vehicle OV1.

The assumed travel route DR may be treated as a region occupied by the trajectory of the motorcycle SO1. The assumed travel route DR may be treated as a lane separate from the lane LA on which the vehicle 1 is traveling. This makes it possible to treat the vehicle 1 and the motorcycle SO1 as traveling in separate lanes when checking the collision risk. Therefore, since the vehicle 1 is traveling in the current lane LA along the lane axis ALA, a longitudinal risk check between the vehicle 1 and the motorcycle SO1, that is, a longitudinal safety distance check, may be omitted or simplified. In other words, detailed longitudinal determination can be omitted or simplified in evaluation of a hazardous situation. That is, the amount of calculation process in the RSS unit 53 can be reduced, and as a result, a delay in calculation process can be reduced or a load on a hardware resource can be reduced.

The simplification of the longitudinal safety distance check may be simplification with respect to the longitudinal safety distance check of the other road user who is treated as traveling in the same lane. The simplification of the longitudinal safety distance check may mean, for example, using an approximate value or an assumption value for a part or all of a substitution value of a parameter such as an acceleration, a response time, or the like, in the calculation of the safety distance indicated in Expressions 1 to 4, instead of an exact value sensed or perceived by the sensors 41 and 42, or acquired by V2X communication. For example, the assumption value may be acquired by referring to a value stored in a database or table stored in a storage medium such as the memory 53a. The simplification of the longitudinal safety distance check may mean simplifying the expression itself used to calculate the safety distance, for example by changing some variables to constants.

In the example illustrated in FIG. 14, the travel route DR of a passing-through moving object is set across two lanes LA1 and LA2 on a two-lane road. That is, a region occupied by a trajectory of the motorcycle SO1 is set along a dividing line that divides the two lanes across the two lanes LA1 and LA2 in the same direction. The situation checking unit 28 may virtually set the travel route DR having the width w when dᵥᵥ is defined as a distance between other vehicles OV5 and OV6 traveling parallel to each other in a direction (lane width direction D2) perpendicular to the lane axial direction D1 along the lane axis ALA and dᵥᵥ>dₜₕᵣₑₛₕ is established.

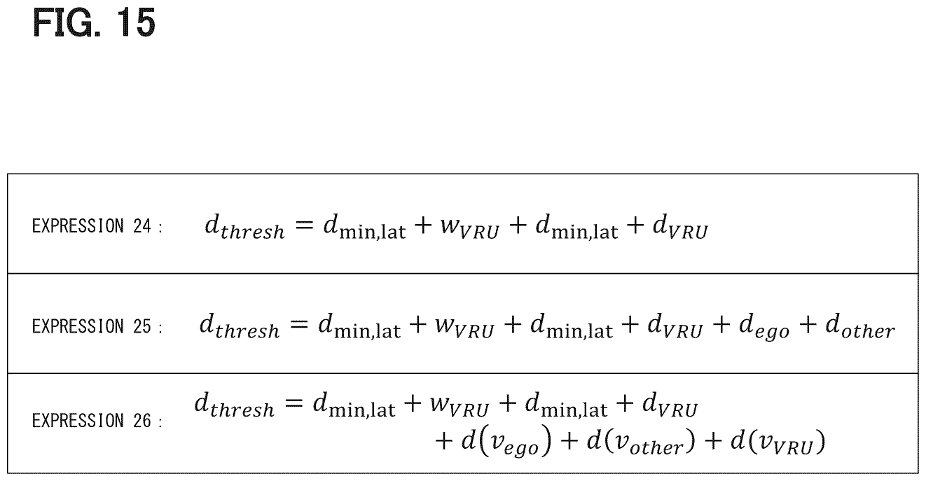

In this example, for example, dₜₕᵣₑₛₕ may be set as indicated in Expressions 24 to 26 in FIG. 15. In Expression 25, d_{ego} is a parameter that is appropriately set according to a type of each vehicle on the lane LA1, in which the vehicle 1 is located, of the two lanes LA1 and LA2. In Expression 25, “dₒₜₕₑᵣ” is a parameter that is set according to a type of each vehicle on the lane LA2, in which the vehicle 1 is not present, of the two lanes LA1 and LA2. In Expression 26, d(v_{ego}) is a parameter that is set according to a velocity of the vehicle on the lane LA1. In Expression 26, d(vₒₜₕₑᵣ) is a parameter that is set according to a velocity of the vehicle on the lane LA2. In Expression 26, d(v_{VRU}) is a parameter that is set according to a velocity of a motorcycle SO2, which is a VRU.

In the example illustrated in FIG. 16, the travel route DR of a passing-through moving object is set across the oncoming lanes LA1 and LA2 on a one-lane road. A scenario in which a passing-through moving object (for example, a motorcycle SO3) passes between the oncoming lanes LA1 and LA2 may be immediately determined to be a potentially hazardous situation, or a hazardous situation, in a situation in which each vehicle on each of the lanes LA1 and LA2 is traveling at or above a certain velocity. Meanwhile, in a situation in which both the lanes LA1 and LA2 are in traffic congestion and the vehicles on both the lanes LA1 and LA2 are stopped or traveling at an ultra-low speed, the situation may be determined to be not hazardous. In this case, the travel route DR for the passing-through moving object may be set.

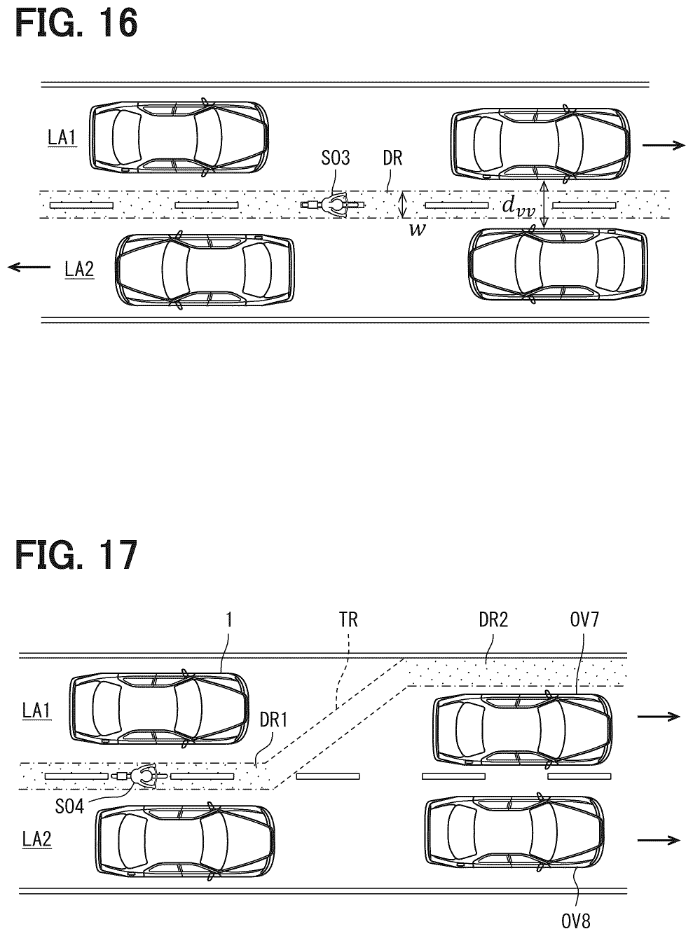

In the example illustrated in FIG. 17, a motorcycle SO4 is traveling as a passing-through moving object on a two-lane road across the two lanes LA1 and LA2, and vehicles OV7 and OV8 in front of the motorcycle SO4 are close to a dividing line between the two lanes, and there is no space for passing-through. For example, it is assumed that there is a space for passing-through on a road end side in a region in front of the motorcycle SO4.

A first travel route DR1 may be set to include a space for passing-through across the two lanes LA1 and LA2, in which the motorcycle SO4 is currently present. A second travel route DR2 may be set to include a space for passing-through, which exists on a road end side in front of the motorcycle SO4. The first travel route DR1 and the second travel route DR2 can be regions exclusively occupied by a trajectory of the motorcycle SO4. In order for the motorcycle SO4 to move from the first travel route DR1 to the second travel route DR2, it is necessary for the motorcycle SO4 to pass through a trajectory crossing the lane LA1 (a broken line portion TR in FIG. 17), in front of the vehicle 1. In other words, the motorcycle SO4 is predicted to move from the first travel route DR1 to the second travel route DR2 passing through the trajectory crossing the lane LA1.

While the motorcycle SO4 is crossing the lane LA1, the vehicle 1 and the motorcycle SO4 may overlap each other in the longitudinal direction, which may result in a collision. During this time, therefore, a longitudinal risk check between the vehicle 1 and the motorcycle SO4, that is, a longitudinal safety distance check, is executed. In this manner, the passing-through moving object may move in a direction that is not necessarily complied with the actual lane. The RSS 26 of the present embodiment reflects directional flexibility of other road users in the setting of the travel route DR.

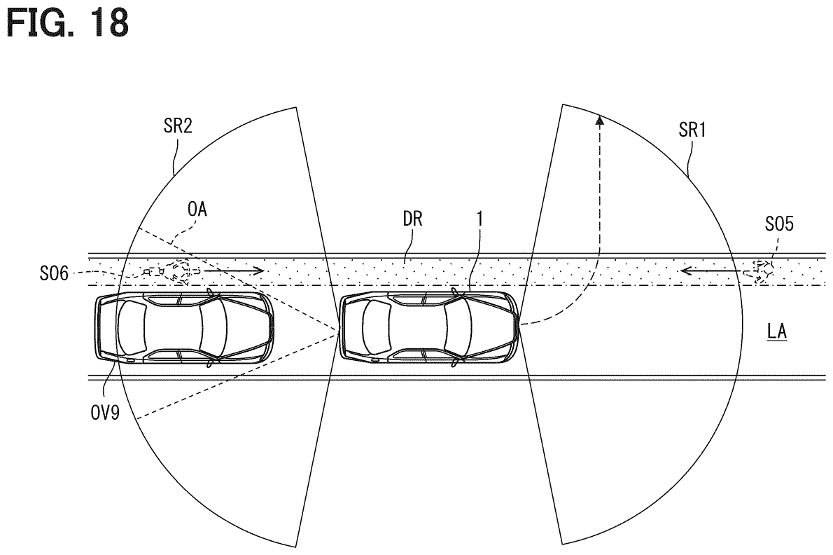

In the example illustrated in FIG. 18, the vehicle 1 tries to turn left from the current lane LA and move to, for example, a parking lot at a roadside. There shall be no sidewalk between the parking lot at the roadside and the lane LA. There are finite ranges SR1 and SR2 in front of and behind the vehicle 1 which can be sensed by sensors, respectively. These ranges may include both a finite angular range and a finite distance range. These ranges SR1 and SR2 may be ranges defined in an operational design domain, for example. A following vehicle OV9 is present behind the vehicle 1, and visibility of the vehicle 1 is limited by the following vehicle OV9. Due to the limited visibility, a occluded area OA is formed on both sides of the following vehicle OV9.

The RSS 26 assumes that there is a possibility that virtual objects SO5 and SO6 as passing-through moving objects appear from at least one of a range other than the ranges SR1 and SR2 which can be sensed by the sensors and the occluded area OA. In the example in FIG. 18, specifically, it is assumed that a passing-through moving object such as a motorcycle, a bicycle, a pedestrian, or the like is present outside the range SR1 which can be sensed by the sensor in front of the vehicle 1, and may appear within the range SR1 at any time. At this time, when it is assumed that vehicle 1 is visible to the virtual object SO5, the virtual object SO5 is assumed to approach along a road end within the lane LA, shifted laterally (or in the lane width direction D2) from the vehicle 1, in order to avoid a collision with the vehicle 1.

Behind the vehicle 1, it is assumed that a passing-through moving object such as a motorcycle, a bicycle, a pedestrian, or the like is present in the occluded area OA, and may appear within the range SR2 which can be sensed by the sensor behind the vehicle 1 at any time.

Kinematic properties of these virtual objects SO5 and SO6 may be set based on a predicted reasonably foreseeable behavior of another road user that is actually perceived. That is, the virtual objects SO5 and SO6 can also be processed together with the other road user who is actually perceived in the series of processes in S11 to S15 in FIG. 10.

Trajectories along which these virtual objects SO5 and SO6 are predicted to travel are assumed to be within the same lane LA as the vehicle 1. In a region occupied by the trajectory, the travel route DR for the passing-through moving object is set. The RSS 26 also supports a collision risk between the virtual objects SO5 and SO6 and the vehicle 1. The travel routes DR assumed for these virtual objects SO5 and SO6 may be treated as a lane separate from the lane LA on which the vehicle 1 is traveling. Therefore, a longitudinal risk check between the vehicle 1 and these virtual objects SO5 and SO6, that is, a longitudinal safety distance check, may be omitted or simplified.

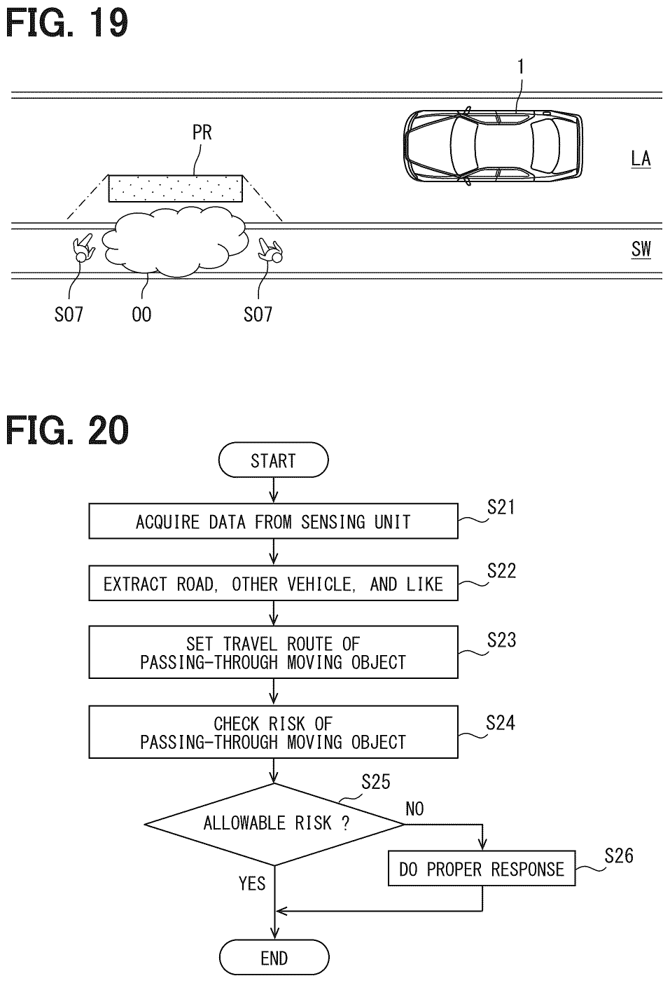

In the example illustrated in FIG. 19, a sidewalk SW is provided on a roadside of the lane LA on which the vehicle 1 is traveling. Meanwhile, in front of the vehicle 1, the sidewalk SW is blocked by an obstacle OO. The obstacle OO may be, for example, a parked car or a mass of snow collected by snow removal on a road.

The RSS 26 assumes that a passing-through moving object enters the lane LA from the sidewalk SW to avoid the obstacle OO. The passing-through moving object here may be a pedestrian SO7. Trajectories along which these pedestrians SO7 are predicted to travel within the lane LA are assumed to be within the same lane LA as the vehicle 1. A passage PR for the passing-through moving object is set in a region occupied by the trajectory. The RSS 26 also supports a collision risk between the pedestrian SO7 and the vehicle 1. The passage PR assumed for these pedestrians SO7 may be treated as a lane separate from the lane LA in which the vehicle 1 is traveling. Therefore, a longitudinal risk check between the vehicle 1 and these pedestrians SO7, that is, a longitudinal safety distance check, may be omitted or simplified.

The results processed by the RSS 26 related to the passing-through moving object may be displayed. The driving system 2 (for example, the acting unit 30 and the HMI output unit 33) may display the assumed behavior of the traffic participant in the vicinity of the vehicle 1 on various information presentation devices, in a mode of an overhead view content that provides an overview of the vicinity of the vehicle 1. The driving system 2 (for example, the acting unit 30 and the HMI output unit 33) may superimpose the assumed passing-through moving object on an image that mimics a shape of the road of the vicinity of the vehicle 1 and display the resultant on the information presentation device. The driving system 2 (for example, the acting unit 30 and the HMI output unit 33) may further superimpose the set travel route DR or the passage PR of the passing-through moving object on this image and display the resultant on the information presentation device.

Further, the driving system 2 (for example, the acting unit 30 and the HMI output unit 33) may display at least one of a longitudinal position, a longitudinal velocity, a longitudinal acceleration, a longitudinal deceleration, a lateral position, a lateral velocity, a lateral acceleration, and a lateral deceleration assumed for the passing-through moving object traveling on the travel route DR or the passage PR on the information presentation device, in association with the travel route DR or the passage PR. When a virtual passing-through moving object is assumed, the driving system 2 (for example, the acting unit 30 and the HMI output unit 33) may display at least one of a longitudinal position, a longitudinal velocity, a longitudinal acceleration, a longitudinal deceleration, a lateral position, a lateral velocity, a lateral acceleration, and a lateral deceleration assumed for the virtual passing-through moving object on the information presentation device, in association with the travel route DR or the passage PR.

The virtual passing-through moving object may be displayed in a display mode for distinguishing from the passing-through moving object actually sensed by the sensing unit 10. For example, the virtual passing-through moving object may be displayed in at least one display mode of a mode with lower luminance, a mode with lower chromaticity, and a mode with higher transmittance for a scenery (for example, a see-through display) compared to an actually sensed passing-through moving object. The virtual passing-through moving object may be distinguished from the actually sensed passing-through moving object by being displayed in a blinking manner.

The result of the process by the RSS 26 related to the passing-through moving object may be generated and recorded as data. The driving system 2 (for example, the RSS 26 and the acting unit 30) may record the assumed behavior for the traffic participant in the vicinity of the vehicle 1 in the storage medium 55c through the recording device 55. The driving system 2 (for example, the RSS 26 and the acting unit 30) may record information on the assumed behavior for the passing-through moving object in the storage medium 55c through the recording device 55. The driving system 2 (for example, the RSS 26 and the acting unit 30) may record information on the set travel route DR or passage PR of the passing-through moving object in the storage medium 55c through the recording device 55.

In more detail, the driving system 2 (for example, the RSS 26 and the acting unit 30) may record at least one of the longitudinal position, the longitudinal velocity, the longitudinal acceleration, the longitudinal deceleration, the lateral position, the lateral velocity, the lateral acceleration, and the lateral deceleration assumed for the passing-through moving object traveling on the travel route DR or the passage PR in the storage medium 55c through the recording device 55, in association with the travel route DR or the passage PR. When the virtual passing-through moving object is assumed, the driving system 2 (for example, the RSS 26 and the acting unit 30) may record at least one of the longitudinal position, the longitudinal velocity, the longitudinal acceleration, the longitudinal deceleration, the lateral position, the lateral velocity, the lateral acceleration, and the lateral deceleration assumed for the virtual passing-through moving object in the storage medium 55c through the recording device 55, in association with the travel route DR or passage PR. A parameter recorded here, such as the longitudinal velocity, may itself include a minimum set of an assumption on the other road user.

### Process Flow

Next, an example of a response processing method for a passing-through moving object by the RSS 26 will be described with reference to FIG. 20. The response processing method includes a check method. This process is realized, for example, by the processor 53b of the RSS unit 53 executing a program stored in the memory 53a. A series of processes from steps S21 to S26 is executed for each predetermined regular time interval or based on a predetermined trigger.

In S21, the situation extraction unit 27 acquires situation data from the sensing unit 10. After the process in S21, the process proceeds to S22.

In S22, the situation extraction unit 27 extracts a positional relationship between a road and another vehicle or the like. That is, a situation is extracted. The situation extraction unit 27 also executes an assumption on the passing-through moving object. The passing-through moving object here includes a passing-through moving object actually perceived by the sensing unit 10 and a virtual passing-through moving object. After the process in S22, the process proceeds to S23.

In S23, the situation extraction unit 27 sets the travel route DR or the passage PR of the passing-through moving object based on a predicted trajectory of the passing-through moving object. After the process in S23, the process proceeds to S24.

In S24, the situation checking unit 28 checks a risk to the passing-through moving object. This risk check may be omitted or simplified by treating the set travel route DR or the set passage PR as a separate lane from the vehicle 1. After the process in S24, the process proceeds to S25.

In S25, the situation checking unit 28 determines whether the risk perceived by the passing-through moving object can be allowed. When the determination result is Yes, the series of processes is ended. When the determination result is No, the process proceeds to S26.

In S26, the response unit 29 derives a proper response for reducing the risk for the passing-through moving object. The response unit 29 outputs the derived proper response to the acting unit 30. After the process in S26, the series of processes is ended.

With the first embodiment described above, a region occupied by a trajectory of a moving object traveling through the lanes LA and LA1 in which the vehicle 1 is present is treated as a separate lane other than the lanes LA and LA1 in which the vehicle 1 is present in a risk check. This makes it possible to reasonably process a predicted behavior of the passing-through moving object, while reducing a load on the processor 53b caused by processing a situation in which many moving objects are in traffic congestion in the same lane. It is possible to reduce frequent occurrence of excessive responses of the vehicle 1 that may result from the risk check. In this manner, when checking a collision risk with the moving object traveling through the lanes LA and LA1, validity of handling for the moving object can be improved.

With the first embodiment, in the risk check, even when the moving object is assumed to be within the lanes LA and LA1 in which the vehicle 1 is present, the region occupied by its trajectory is treated as a separate lane, thereby omitting or simplifying a check of a longitudinal safety distance between the vehicle 1 and the moving object. Such omission or simplification can reliably reduce the load on the processor 53b. It is possible to avoid a situation in which the vehicle 1 makes an unnecessary deceleration response at a timing when a longitudinal vehicle-to-vehicle distance becomes extremely small, which may inevitably occur during the passing-through.

With the first embodiment, a virtual moving object is assumed in the occluded area OA that is generated due to limited visibility of the vehicle 1. This makes it possible to early foresee a collision risk with the passing-through moving object that is not actually visible to the vehicle 1.

With the first embodiment, the virtual moving object is assumed to be outside a range which can be sensed by a sensor provided on the vehicle 1. This makes it possible to early foresee a collision risk with the passing-through moving object that is not actually visible to the vehicle 1.

With the first embodiment, when a passing-through moving object is assumed at an end portion of the lanes LA and LA1 in which the vehicle 1 is present, when a distance in the lane width direction D2 between the end portion and the vehicle 1 or another moving object is more than a predetermined distance, the virtual travel route DR assumed for the moving object is set, which is a region having a predetermined width that is treated as a lane separate from the lanes LA and LA1 in which the vehicle 1 is present. That is, a trajectory is predicted depending on whether there is a space through which the moving object can pass. Therefore, validity of handling the moving object can be improved.

### Second Embodiment

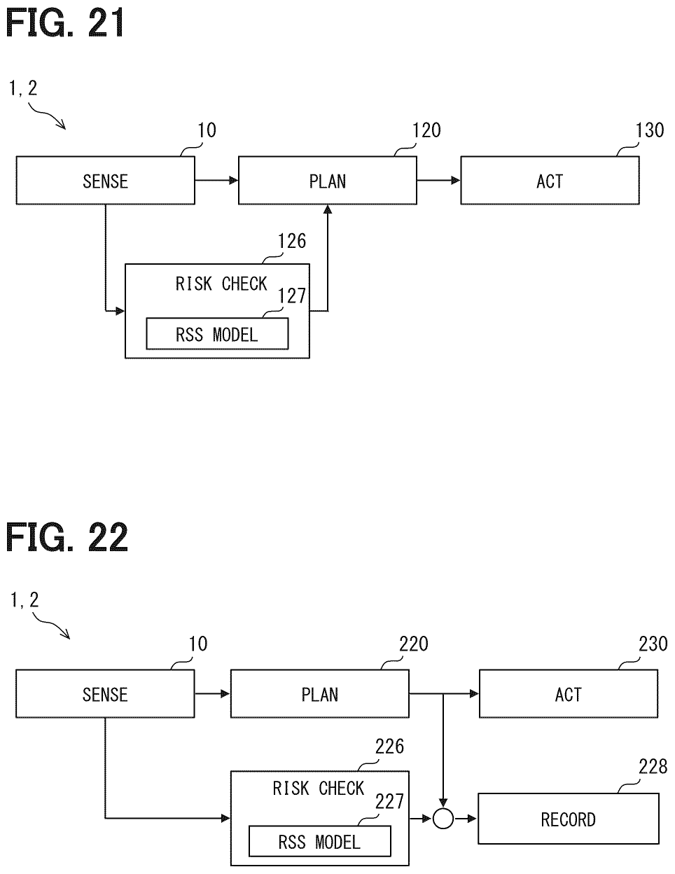

As illustrated in FIG. 21, a second embodiment is a modification example of the first embodiment. The second embodiment will be described focusing on a difference from the first embodiment.

In the second embodiment, an RSS may be mounted with a specialized risk check function without deriving a proper response. In this example, in the driving system 2, a risk checking unit 126 may be constructed as a functional block separate from the sensing unit 10, the planning unit 120, and the acting unit 130.

The risk checking unit 126 acquires situation data from the sensing unit 10. The risk checking unit 126 extracts a situation from the situation data, and assumes a safety-related object. The object here may include at least one of a passing-through moving object actually sensed by the sensing unit 10 and a virtual passing-through moving object.

The risk checking unit 126 checks a risk to the assumed object, and outputs a check result to the planning unit 20. In order to check the risk here, an RSS model 127 implemented in the risk checking unit 126 in a form of a program, for example, may be used. The risk check may be executed in the same manner as in the first embodiment. The check result may include a determination result as to whether the risk is allowable. The check result may include a numerical value for a safety envelope or a safety distance used by the RSS model 127 in its calculation.

The planning unit 120 plans driving of the vehicle 1 according to the check result acquired from the risk checking unit 126. The planning unit 120 may make a comprehensive determination based on the situation data acquired from the sensing unit 10 and the check result to plan the driving of the vehicle 1. Alternatively, the planning unit 120 may plan the driving of the vehicle 1 based on the situation data acquired from the sensing unit 10, and modify the plan when the risk checking unit 126 notifies of existence of an unallowable risk. The acting unit 130 does not need to apply a restriction of the RSS, but simply realizes a trajectory plan acquired from the planning unit 120 through the motion actuator 60 as is.

In the second embodiment, the risk checking unit 126 may be realized by the RSS unit 53 in the same manner as in the first embodiment. The risk checking unit 126 may be realized by the dedicated computer 51 of the processing system 50. The hardware that realizes the function of the risk checking unit 126 corresponds to a check device.

### Third Embodiment

As illustrated in FIG. 22, a third embodiment is a modification example of the first embodiment. The third embodiment will be described focusing on a difference from the first embodiment.

In the third embodiment, an RSS may be mounted specifically for a recording function, and not for use in deriving driving and an act of the vehicle 1, for use in subsequent verification and a validity check of the driving system 2. In this example, in the driving system 2, a risk checking unit 226 and a recording unit 228 may be constructed as functional blocks separate from the sensing unit 10, the planning unit 220, and the acting unit 230.

The risk checking unit 226 acquires situation data from the sensing unit 10. The risk checking unit 226 assumes a safety-related object, and executes a risk check using the RSS model 227, in the same manner as in the second embodiment. The risk checking unit 226 provides a check result to the recording unit 228.

The recording unit 228 organizes the processing result by the planning unit 220 and the check result by the risk checking unit 226, and executes recording sequentially or periodically. The recording may be recording to the on-board storage medium 55c. The recording may be off board recording, that is, recording to the storage medium 96a of the external system 96 by transmitting the record data by the communication system 43.

The recording unit 228 may generate data that conforms to a data format of a data storage system for automated driving (DSSAD) when organizing the processing result by the planning unit 220 and the check result by the risk checking unit 226. When the data format of the DSSAD does not support recording of the risk check result, an extended data format suitable for recording of the risk check result may be adopted. When the data format of the DSSAD does not support recording the risk check result, the risk check result may be generated as separate dedicated data.

In the third embodiment, the risk checking unit 226 may be realized by the RSS unit 53, in the same manner as in the first embodiment. The risk checking unit 226 may be realized by the dedicated computer 51 of the processing system 50. The hardware that realizes the function of the risk checking unit 226 corresponds to a check device.

An architecture illustrated in FIG. 22 may be used for simulation in advance verification and a validity check of the driving system 2. In this case, hardware that realizes the architecture in FIG. 22 does not need to be mounted in the vehicle 1. That is, all processes may be executed on a computer for simulation. In this case, the simulation computer corresponds to an off-board checker. Such a simulation may be publicly executed by a certification agency that certificates the driving system 2.

### Fourth Embodiment

A fourth embodiment is a modification example of the first embodiment. The fourth embodiment will be described focusing on a difference from the first embodiment.

In the fourth embodiment, in an algorithm of a state transition for the vehicle 1 in response to a passing-through moving object, the passing-through moving object is treated as when the passing-through moving object travels in a separate lane, thereby reducing frequent occurrence of excessive responses by the vehicle 1.

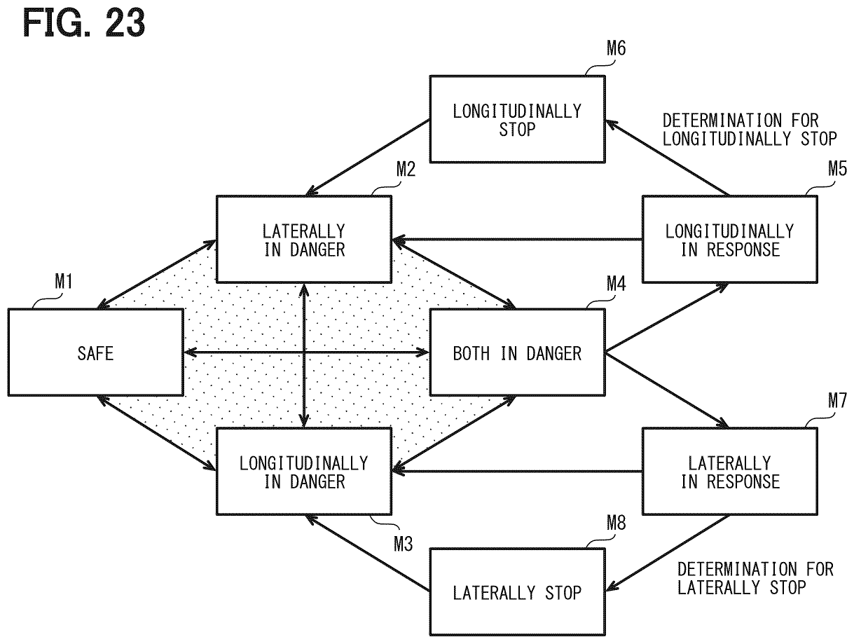

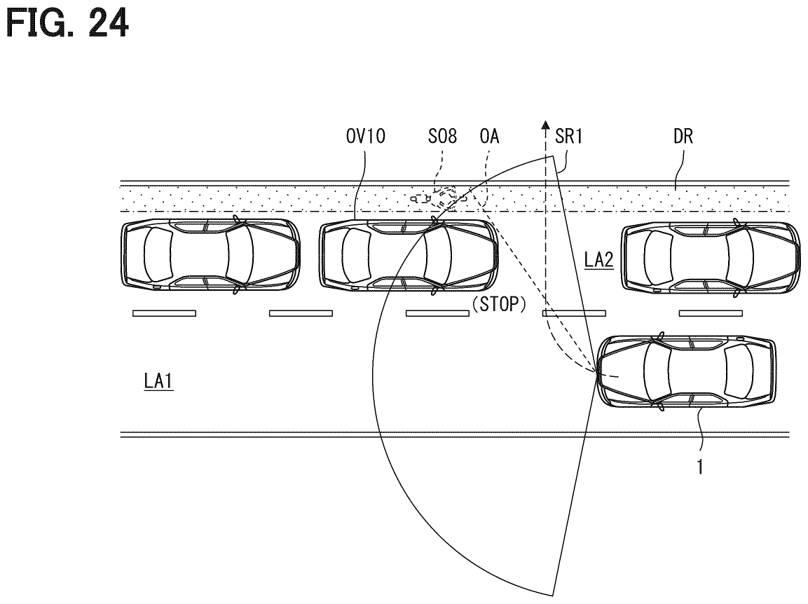

As illustrated in FIG. 23, the state transition of the vehicle 1 used to calculate the proper response is illustrated. Four states of safety M1, laterally in danger M2, longitudinally in danger M3, and both (that is, laterally and longitudinally) in danger M4 transition to each other. Longitudinally in response M5, longitudinally stop M6, laterally in response M7, and laterally stop M8 are states after a start of execution of a proper response including braking.

The states M1 to M4 may transition to each other based on a longitudinal safety distance and a lateral safety distance. In detail, when the current distance to another road user in the longitudinal direction (hereinafter, referred to as the current longitudinal distance) is more than the longitudinal safety distance and the current distance to the other road user in the lateral direction (hereinafter, referred to as the current lateral distance) is more than the lateral safety distance, the state is safe M1. When the current longitudinal distance is more than the longitudinal safety distance and the current lateral distance is equal to or less than the lateral safety distance, the state is the laterally in danger M2. When the current longitudinal distance is equal to or less than the longitudinal safety distance and the current lateral distance is more than the lateral safety distance, the state is the longitudinally in danger M3. When the current longitudinal distance is equal to or less than the longitudinal safety distance and the current lateral distance is equal to or less than the lateral safety distance, the state is the both in danger M4. The state transitions described here are state transitions for the other road user in a separate lane (for example, an adjacent lane).

In other words, the safety M1 is a state in which a collision risk between the vehicle 1 and the other road user is lower than a preset threshold value in both the longitudinal direction and the lateral direction. The laterally in danger M2 is a state in which a longitudinal collision risk is lower than a preset threshold value and a lateral collision risk is higher than a preset threshold value. The longitudinally in danger M3 is a state in which the lateral collision risk is lower than the preset threshold value and the longitudinal collision risk is higher than the preset threshold value. The both in danger M4 is a state in which the collision risk is higher than the preset threshold value in both the longitudinal direction and the lateral direction.

The transition from the both in danger M4 to the longitudinally in response M5 and the laterally in response M6 occurs when a condition for transitioning to each of the states M5 and M6 is established. For example, when a longitudinal hazardous state elapse time is equal to or higher than a lateral hazardous state elapse time and is higher than a response time, the state transitions to the longitudinally in response M5 and a proper response, including braking, is started. For example, when a lateral hazardous state elapse time is equal to or higher than a longitudinal hazardous state elapse time and is higher than a response time, the state transitions to the laterally in response M7 and a proper response, including braking, is started.

When, in the longitudinally in response M5, the current longitudinal distance is returned to a state higher than the longitudinal safety distance, the state becomes the laterally in danger M2. In the longitudinally in response M5, when a determination for longitudinally stop is executed and it is determined that the vehicle is to be stopped, the state becomes the longitudinally stop M6. When the vehicle 1 is stopped and the current longitudinal distance is returned to a state higher than the longitudinal safety distance, the state becomes the laterally in danger M2.

When the current lateral distance is returned to a state higher than the lateral safety distance during the laterally in response M7, the state becomes the longitudinally in danger M3. In the laterally in response M7, when a determination for laterally stop is executed and it is determined that the vehicle is to be stopped, the state becomes the laterally stop M8. When the current lateral distance is returned to a state higher than the lateral safety distance by laterally stop of the vehicle 1 (for example, stop of lane change or the like), the state becomes the longitudinally in danger M3.

That the transition to the longitudinally stop M6 and the laterally stop M8 may correspond to a DDT fallback. The stop determination such as the determination for longitudinally stop and the determination for laterally stop may be executed by the planning unit 20 instead of the RSS 26.

Next, a state transition for another road user traveling in the same lane as the vehicle 1 will be described, which differs from a state transition for the other road user in a separate lane (for example, an adjacent lane). When the other road user is traveling in the same lane as the vehicle 1, a state in the lateral direction is always considered unsafe, that is, hazardous, regardless of a relationship between the current lateral distance and the lateral safety distance. Therefore, the vehicle 1 basically transitions between two states, the laterally in danger M2 and the both in danger M4, among the states M1 to M4 in which a proper response including braking is not executed.

Therefore, when a passing-through moving object passing through the same lane as the vehicle 1 is traveling is treated as traveling on the same lane, the state will definitely become the both in danger M4 when traveling side by side, overtaking, or being overtaken. Therefore, not only the calculation of the transition conditions to the laterally in response M7 and laterally in response M9 but also the execution of proper response including braking occur frequently. Therefore, the RSS 26 avoids such a situation by treating the passing-through moving object as when the passing-through moving object is traveling in a separate lane. In this case, a region occupied by a trajectory of the passing-through moving object may or may not be set as the travel route DR as the separate lane.

With the fourth embodiment described above, when a collision risk in both the longitudinal and lateral directions is determined as a hazardous state, it is determined whether to execute a proper response including braking. Even when a passing-through moving object is assumed to be in a lane in which the vehicle 1 is present, a region occupied by a trajectory is treated as a separate lane, thereby reducing a possibility that the state is determined to be hazardous in both the longitudinal and lateral directions. Therefore, it is possible to reduce frequent occurrence of excessive responses to the passing-through moving object.

With the fourth embodiment, for another road user in a separate lane other than the lane in which the vehicle 1 is present, it is determined that the lateral direction is in a hazardous state when a predetermined condition is satisfied. On the other hand, for the other road user in the same lane as the lane in which the vehicle 1 is present, a collision risk is checked by using an algorithm that determines the lateral hazardous state. By treating the passing-through moving object as being present in a separate lane, it is possible to avoid unconditionally determining that the lateral direction is in a hazardous state. In this manner, it is possible to reduce frequent occurrence of excessive responses to the passing-through moving object.

With the fourth embodiment, a condition for determining the collision risk with respect to a passing-through moving object is a condition with which the collision risk is determined to be lower, in the same manner as the other road user present in a separate lane from the vehicle. As a result, since a possibility that the collision risk is determined to be higher than a preset threshold value becomes low, it becomes difficult to reach a situation for determining whether to execute a proper response, including braking. Therefore, it is possible to reduce frequent occurrence of excessive responses to the passing-through moving object. In this manner, when checking the collision risk with the moving object traveling through a lane, validity for the moving object can be improved.

With the fourth embodiment, a longitudinal collision risk and a lateral collision risk are checked, respectively. The determination as to whether to execute a proper response is executed when it is determined that the collision risk is higher than a preset threshold value, in both the longitudinal and lateral directions. Further, between the longitudinal and lateral directions, a condition for determining the lateral collision risk is changed depending on handling of the lane by the other road user.

The handling of the lane of the passing-through moving object is such that, even when the passing-through moving object is present in the lane in which the vehicle 1 is present, in determination as to the lateral collision risk, the passing-through moving object is treated as being present in a separate lane other than the lane in which the vehicle 1 is present. Therefore, it is possible to reduce frequent occurrence of excessive responses to the passing-through moving object.

With the fourth embodiment, when the other road user is present in a separate lane from the vehicle 1, a condition for determining the lateral collision risk is whether a lateral distance between the vehicle 1 and the other road user is higher than the lateral safety distance. On the other hand, when the other road user is present in the same lane as the vehicle 1, it is determined that the lateral collision risk is higher than a preset threshold value. After changing the conditions in this manner, the passing-through moving object is treated as being present in a separate lane other than the lane in which the vehicle 1 is present, so that frequent occurrence of excessive responses to the passing-through moving object can be reduced.

### Other Embodiments

Although multiple embodiments are described above, the present disclosure is not construed as being limited to these embodiments, and can be applied to various embodiments and combinations within a scope that does not depart from the gist of the present disclosure.

In still another embodiment, the RSS 26 may improve accuracy of assuming a passing-through moving object by using information received by the communication system 43 by V2X communication from at least one of another vehicle and a roadside device. The situation extraction unit 27 may acquire and use at least one of information on an object outside the ranges SR1 and SR2 which can be sensed by the sensor and information on an object in the occluded area OA via V2X communication.

For example, when acquiring information that a passing-through moving object is present outside the ranges SR1 and SR2 which can be sensed by the sensor and in the occluded area OA, the RSS 26 may set the travel route DR of the passing-through moving object based on the information that the passing-through moving object is present. On the other hand, when acquiring information that there is no passing-through moving object outside the ranges SR1 and SR2 which can be sensed by the sensor and in the occluded area OA, the RSS 26 does not need to assume a virtual passing-through moving object in the region in which no passing-through moving object is present.

In still another embodiment, the RSS 26 may also support the scenario illustrated in FIG. 24. In an example illustrated in FIG. 24, the vehicle 1 tries to turn right from the current lane LA1 across the oncoming lane LA2, and move to, for example, a parking lot of a roadside. There is no sidewalk between the parking lot of the roadside and the lane LA2. The oncoming lane LA2 is in traffic congestion. The vehicle 1 tries to turn right through a gap in a queue of vehicles in the traffic congestion in the oncoming lane LA2. In front of the vehicle 1, there is each finite range SR1 which can be sensed by a sensor. This range SR1 may include both a finite angular range and a finite distance range. In the oncoming lane LA2, a stopped oncoming vehicle OV10 is present in the range SR1 which can be sensed by the sensor, and a field of view of the vehicle 1 is restricted by the oncoming vehicle OV10. Due to the restricted field of view, the occluded area OA is formed on an opposite side of the vehicle 1 across the oncoming vehicle OV10.

The RSS 26 assumes that there is a possibility that another road user may appear from the occluded area OA. In the example in FIG. 24, specifically, it is assumed that a virtual object SO8, such as a motorcycle, a bicycle, a pedestrian, or another passing-through moving object, is present in the occluded area OA, and may appear at any time within the range SR1 which can be sensed by a sensor on a rear side of the vehicle 1. A trajectory along which the virtual object SO8 is predicted to travel is assumed to be within the oncoming lane LA2. In a region occupied by the trajectory, the travel route DR of the virtual object SO8 is set. The RSS 26 also supports for a collision risk between the virtual object SO 8 and the vehicle 1.

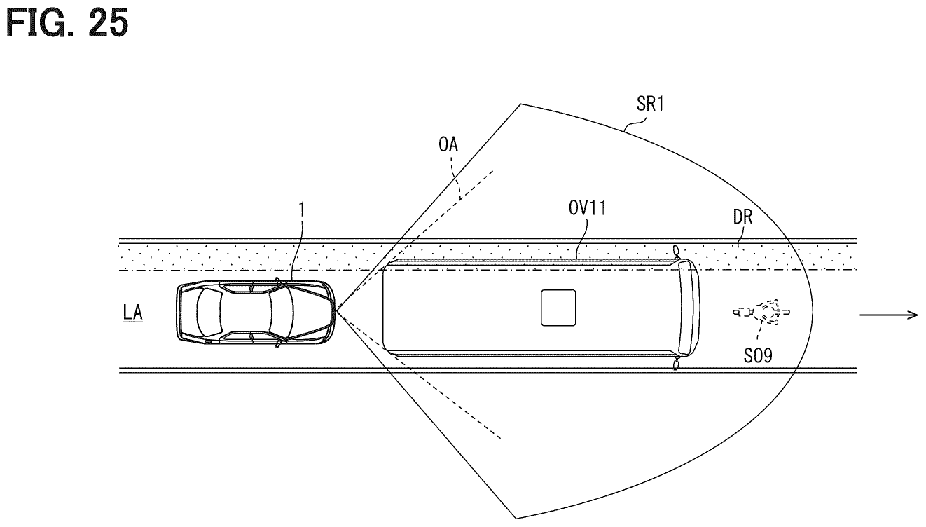

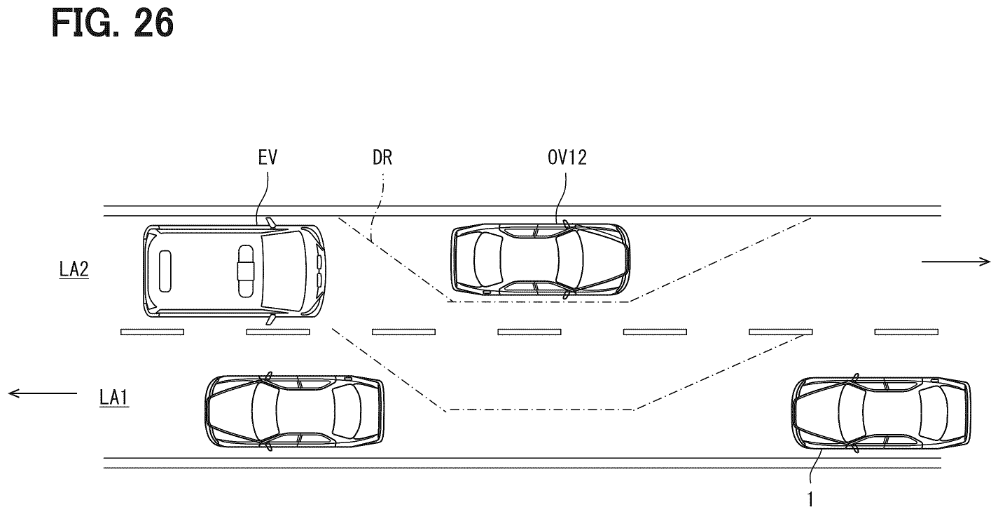

In still another embodiment, the RSS 26 may also response a scenario illustrated in FIG. 25. In this scenario, the vehicle 1 is traveling behind a large vehicle OV11, which is another large road user, in the lane LA. The large vehicle OV11 may be, for example, a truck, a trailer, a bus, or the like. As a result, most of the range SR1 which can be sensed by a sensor in front of the vehicle 1 is blocked off, forming the occluded area OA. In this case, the RSS 26 may assume that a virtual object SO9, such as a VRU of a motorcycle or a small vehicle, is traveling further ahead of the large vehicle OV11. The RSS 26 may assume a possibility that the virtual object SO9 appears from the occluded area OA at any time when the large vehicle OV11 tries to overtake the virtual object SO9. The RSS 26 may assume that the virtual object SO9 is a passing-through moving object such as a motorcycle. Under such an assumption, the RSS 26 may set, as the travel route DR, a region occupied by a trajectory assumed for the virtual object SO9 when the large vehicle OV11 overtakes the virtual object SO9.

In still another embodiment, the RSS 26 may also support a scenario illustrated in FIG. 26. As illustrated in FIG. 26, a passing-through moving object is an emergency vehicle EV. The emergency vehicle EV may be, for example, an ambulance, a fire engine, a police vehicle, or the like. For example, it is assumed that while the vehicle 1 is traveling in the current lane LA1, the emergency vehicle EV traveling in the oncoming lane LA2 passes between vehicles and crosses into the lane LA1 to overtake another vehicle OV12 making an emergency evacuation in the same lane LA2. In this case, the RSS 26 may treat the emergency vehicle EV as a passing-through moving object, and generate the assumed travel route DR for the emergency vehicle EV. That is, the RSS 26 may also support for a collision risk between the emergency vehicle EV and the vehicle 1.

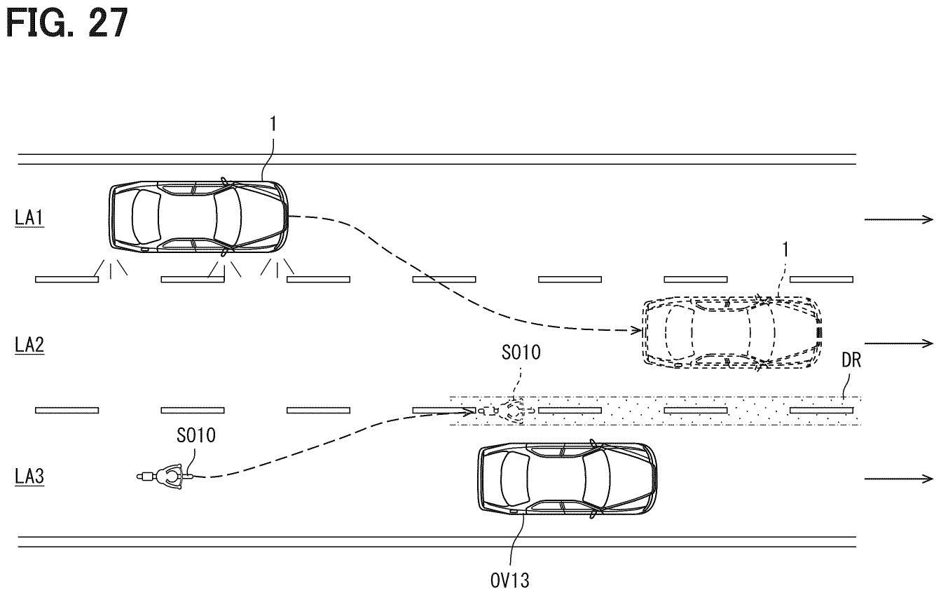

In still another embodiment, the RSS 26 may also support a scenario illustrated in FIG. 27. This scenario is a scenario in which the vehicle 1 is on a multi-lane road (for example, a road having three or more lanes in each direction) with an open lane. For example, as illustrated in FIG. 27, on a three-lane road, the vehicle 1 is traveling in the lane LA1 at one end, the center lane LA2 is empty, and another preceding vehicle OV13 and a following motorcycle SO10 are traveling in a lane LA3 at the other end. The vehicle 1 tries to change the lane to the center lane LA2 by operating a blinker, and the motorcycle SO10 also tries to move laterally toward the center lane LA2 to overtake the preceding vehicle OV13.

In such a scenario, as an assumed trajectory for the motorcycle SO10 upon detecting the lane change of the vehicle 1, the RSS 26 may assume a trajectory of passing-through between the preceding other vehicle OV13 and the vehicle 1 after the lane change. The RSS 26 may then set the travel route DR for the motorcycle SO10 in a region occupied by the trajectory. In this manner, the RSS 26 may also provide support for a collision risk assumed after the vehicle 1 changes the lane.

In supporting the various scenarios described in the first to third embodiments and other embodiments, when the RSS 26 assumes or determines that another road user is a passing-through moving object, it is not necessary to assume the trajectory and set the travel route DR for treating the passing-through moving object as being present in a separate lane. That is, in the various scenarios, the condition for the state transition in the fourth embodiment may be set on a premise that the passing-through moving object is present in a separate lane.

In still another embodiment, generation of the travel route DR by assuming a passing-through moving object may be realized by using a safety model other than the RSS model. For example, the driving system 2 may implement a safety force field (SFF) model.

For example, when calculating a claimed set of a passing-through moving object by a spatio-temporal analysis in the SFF model, the driving system 2 may set the travel route DR of the passing-through moving object. The claimed set may be defined as a spatio-temporal volume between a safety procedure schedule and a maximum braking schedule. The maximum braking schedule may be calculated by using a reasonably foreseeable minimum assumed longitudinal deceleration.

The driving system 2 may calculate a space-time asserted by the passing-through moving object as an actor by limiting the space-time to a range of the travel route DR set for the passing-through moving object. That is, by omitting or simplifying the spatio-temporal analysis outside the range of the travel route DR, a processing load for calculating the claimed set can be reduced.

In still another embodiment, the RSS unit 53 may be integrated with the dedicated computer 51. In still another embodiment, the RSS unit 53 may be provided independently of the processing system 50, and configured to monitor an operation of the processing system 50 from outside.

The scenarios illustrated in FIG. 11, FIG. 14, FIG. 16 to FIG. 19, and FIG. 23 are intended to be applied to countries or regions where people drive on a left side of a road, and it is possible to reverse left and right sides of these scenarios and apply the scenarios to countries or regions where people drive on a right side of a road.

The processing unit and the method thereof described in the present disclosure may be implemented by a special purpose computer, which includes a processor programmed to execute one or more functions performed by computer programs. Alternatively, a device and its method according to the present disclosure may be realized by a dedicated hardware logic circuit. Alternatively, the device and its method according to the present disclosure may be realized by one or more dedicated computers including a combination of a processor executing a computer program and one or more hardware logic circuits. The computer program may also be stored on a computer-readable and non-transitory tangible storage medium as an instruction executed by a computer.

### Description of Terms

The following describes terms related to this disclosure. This description is included in the embodiments of this disclosure.

A road user may be a human who uses a road including a sidewalk and other adjacent spaces. The road user may include a pedestrian, a cyclist, other VRUs, and a vehicle (for example, an automobile driven by a human or a vehicle equipped with an automated driving system).

A dynamic driving task (DDT) may be a real-time operation function and a real-time strategic function for operating a vehicle in traffic.

An automated driving system may be a set of hardware and software capable of continuously executing all DDTs regardless of whether a limitation to a specific operational design domain exists.

Safety of the intended functionality (SOTIF) may mean absence of an unreasonable risk caused by functional insufficiency for an intended function or its implementation.

A driving policy may be a strategy and a rule defining a control action at a vehicle level.

A scenario may be a description of the temporal relationships between several scenes in a series of scenes, including goals and values in a specific situation influenced by actions and events. The scenario may be a description of consecutive activities in time series in which a vehicle as a main-object, its all external environments, and their interactions in a process of executing a specific driving task are integrated.

A triggering condition may be a specific condition of a scenario functioning as a trigger for a response that is a response of a subsequent system and that contributes to inability to prevent, detect, and reduce hazard behavior and reasonably foreseeable indirect misuse.

A proper response may be an act that is significant to avoid and ameliorate a hazardous situation in a reasonably foreseeable scenario in which other safety-related objects are operating within an assumption range.

The operational design domain (ODD) may be a specific condition which is designed such that a given (automated) driving system functions.

The safety-related model may be representation of a safety-related aspect of the driving act based on assumptions on the reasonably foreseeable behavior of another road user. The safety-related models may be an on-board or off-board safety check device or safety analysis device, a mathematical model, a set of more conceptual rules, a set of scenario-based behaviors, or a combination thereof.

A formal model may be a model represented in a formal representation used for system performance verification.

A safety envelope may be a set of a restriction and a condition that are designed for a (automated) driving system to operate as a target for a constraint or a control in order to maintain an operation at an allowable risk level. The safety envelope may be a general concept that can be used to deal with all principles on which the driving policy can be based. According to this concept, an ego-vehicle operated by the (automated) driving system can have one or multiple boundaries around the ego-vehicle.

A response time may be a time required for the road user to sense a specific stimulus and start executing a response (braking, steering, acceleration, stopping, or the like) in a given scenario.

A situation is a factor that can affect a behavior of a system, and may include traffic conditions, weather, and the behavior of the ego-vehicle.

A hazardous situation may be an increased risk for a potential violation of the safety envelope and also represents an increased risk level existing in the DDT.

A reasonably foreseeable may mean being technically reliable and having a credible or measurable probability of occurrence.

A vulnerable road user (VRU) may be a road user not occupying a vehicle such as a passenger vehicle, a public transport agency, or a train. The VRU may be an unprotected road user, such as a motorcyclist, a cyclist, a pedestrian, or a person with a disability or reduced mobility and orientation.

A minimal risk maneuver (MRM) may be a function of an automated driving system to transition a vehicle between a nominal condition and a minimal risk condition (MRC).

A DDT fallback may be a response by a driver or an automated system to either execute a DDT or transition to a minimal risk condition after a failure occurs or upon detection of a functional insufficiency or a potentially hazardous behavior. The DDT fallback may be a method of transition control from autonomy to control by a driver or other system using takeover/fallback states and associated use cases.

### Disclosure of Technical Ideas

The present disclosure further provides multiple technical features. Some items may be written in a multiple dependent form with subsequent items referring to the preceding item as an alternative. The terms described in the multinomial dependent form define a plurality of technical ideas.

### Technical Idea 1

A check device used for driving of a vehicle includes at least one processor. The processor is configured to execute: assuming a moving object passing through a lane in which the vehicle is present; and checking a collision risk between the vehicle and the moving object, by treating the moving object as being present in a separate lane other than the lane in which the vehicle is present even when the moving object is present in the lane in which the vehicle is present.

With this technical idea, it is possible to improve validity of handling the moving object traveling through the lane.

### Technical Idea 2

A storage medium for storing data related to driving of a vehicle processed by a driving system stores: information on a behavior of a passing-through moving object passing through a vicinity of the vehicle, which is assumed by the driving system; and information on a region occupied by a trajectory predicted for the passing-through moving object, which is set by the driving system, in association with each other.

With this technical idea, it is easier for the driving system to verify and check validity of the assumption on the passing-through moving object.

### Technical Idea 3

A method for generating data related to driving of a vehicle by at least one processor includes: specifying kinematic properties related to a behavior of a passing-through moving object passing through a vicinity of the vehicle; setting a region occupied by a trajectory predicted for the passing-through moving object; and generating data in which the kinematic properties and the region are associated with each other.

With this technical idea, it is easier for the driving system to verify and check validity of the assumption on the passing-through moving object.

### Technical Idea 4

The method according to technical idea 1 further includes: storing the data and information on a proper response calculated by treating the region as a separate lane, in association with each other.

### Technical Idea 5

A system for displaying using a visual information presentation type information presentation device includes at least one processor. The processor is configured to: cause the information presentation device to display a moving object passing through a vicinity of the vehicle; and cause the information presentation device to display an image obtained by superimposing a trajectory and a travel route along which the moving object is predicted to travel onto an image in which the moving object is displayed.

### Technical Idea 6

A driving system used for driving of a vehicle includes: a sensor; a computer that acquires sensor data from the sensor, generates an environment model of a vicinity of the vehicle based on the sensor data, plans the driving of the vehicle by using the environment model, and controls a motion actuator of the vehicle based on the plan; and an RSS unit that is a unit which implements an RSS model and checks a collision risk of the vehicle. The RSS unit is configured to: acquire the environment model from the computer; assume, based on the environment model, a trajectory along which a passing-through moving object passing through a lane in which the vehicle is present is predicted to travel such that the trajectory includes an inside of the lane; check the collision risk between the vehicle and the passing-through moving object, by treating at least a part of a region occupied by the trajectory as a separate lane other than the lane in which the vehicle is present; derive a proper response when a value of the collision risk exceeds a preset risk value; and generate a request to the motion actuator of the vehicle by applying the proper response to the plan.

With this technical idea, it is possible to improve validity of handling the moving object traveling through the lane.

### Technical Idea 7

A driving method used for driving of a vehicle includes: generating an environment model by acquiring sensor data from a sensor of the vehicle; planning the driving of the vehicle by using the environment model; assuming, based on the environment model, a trajectory along which a passing-through moving object passing through a lane in which the vehicle is present is predicted to travel such that the trajectory includes an inside of the lane; checking a collision risk between the vehicle and the passing-through moving object, by treating at least a part of a region occupied by the trajectory as a separate lane other than the lane in which the vehicle is present; deriving a proper response when a value of the collision risk exceeds a preset risk value; generating a request to a motion actuator of the vehicle by applying the proper response to the plan; and controlling the motion actuator.

With this technical idea, it is possible to improve validity of handling the moving object traveling through the lane.

### Technical Idea 8

A check device used for driving of a vehicle includes at least one processor. The processor is configured to execute: checking a collision risk between the vehicle and another road user; determining whether to execute a proper response including braking, when the collision risk is determined to be higher than a preset threshold value; changing a condition for determining the collision risk such that the collision risk is determined to be higher when the other road user is in the same lane as the vehicle than when the other road user is in a separate lane from the vehicle; assuming a moving object passing through a lane in which the vehicle is present, as the other road user; and treating, in the determining of the collision risk, the moving object as being present in the separate lane other than the lane in which the vehicle is present even when the moving object is present in the lane in which the vehicle is present.

What is claimed is:

1. A check device used for driving of a vehicle comprising:
at least one processor; and
a non-transitory computer-readable storage medium storing instructions that, when executed by the at least one processor, cause the at least one processor to execute:
assuming a trajectory along which a moving object passing through a lane in which the vehicle is present is predicted to travel such that the trajectory includes an inside of the lane; and
checking a collision risk between the vehicle and the moving object, by treating at least a part of a region occupied by the trajectory as a separate lane other than the lane in which the vehicle is present.

2. The check device according to claim 1, wherein
the processor is configured to further execute:
determining whether to execute a proper response including braking when for the collision risk, both a longitudinal direction and a lateral direction are determined to have a hazardous state, and
in the checking, reducing a possibility that both the longitudinal direction and the lateral direction are determined to have the hazardous state by treating the region occupied by the trajectory as the separate lane even when the moving object is assumed to be in the lane in which the vehicle is present.

3. The check device according to claim 2, wherein
the processor is configured to execute:
in the checking, determining that the lateral direction has the hazardous state when a predetermined condition is satisfied for another road user present in a separate lane other than the lane in which the vehicle is present; and checking the collision risk for the other road user present in a same lane as the lane in which the vehicle is present, by using an algorithm that determines that the lateral direction has the hazardous state.

4. The check device according to claim 1, wherein
the processor is configured to execute:
in the checking, simplifying a check for a longitudinal safety distance between the vehicle and the moving object by treating the region occupied by the trajectory as the separate lane even when the moving object is assumed to be in the lane in which the vehicle is present.

5. The check device according to claim 1, wherein
the processor is configured to execute:
in the checking, omitting a check for a longitudinal safety distance between the vehicle and the moving object by treating the region occupied by the trajectory as the separate lane even when the moving object is assumed to be in the lane in which the vehicle is present.

6. The check device according to claim 1, wherein
the moving object is a virtual moving object assumed in a occluded area generated due to limited visibility of the vehicle.

7. The check device according to claim 1, wherein
the moving object is a virtual moving object assumed to be outside a range which is sensible by a sensor provided in the vehicle.

8. The check device according to claim 1, wherein
the processor is configured to execute:
setting a virtual travel route assumed for the moving object, which is the region having a predetermined width that is treated as a separate lane other than the lane in which the vehicle is present, when the moving object is assumed to be at an end portion of the lane in which the vehicle is present and a distance in a lane width direction between the end portion and the vehicle or another moving object is higher than a predetermined distance.

9. A check method for a collision risk of a vehicle, executed by at least one processor, the check method comprising:
assuming a trajectory along which a moving object passing through a lane in which the vehicle is present is predicted to travel such that the trajectory includes an inside of the lane; and
checking the collision risk between the vehicle and the moving object, by treating at least a part of a region occupied by the trajectory as a separate lane other than the lane in which the vehicle is present.

10. A check device used for driving of a vehicle, the check device comprising:
at least one processor; and
a non-transitory computer-readable storage medium storing instructions that, when executed by the at least one processor, cause the at least one processor to execute:
checking a collision risk between the vehicle and another road user;
determining whether to execute a proper response including braking, when the collision risk is determined to be higher than a preset threshold value;
changing a condition for determining the collision risk such that the collision risk is determined to be higher when the other road user is in a same lane as the vehicle than when the other road user is in a separate lane from the vehicle;
assuming a moving object passing through a lane in which the vehicle is present, as the other road user; and
treating, in the determining of the collision risk, the moving object as being present in a separate lane other than the lane in which the vehicle is present even when the moving object is present in the lane in which the vehicle is present.

11. The check device according to claim 10, wherein
the checking of the collision risk includes checking each of the collision risk in a longitudinal direction and the collision risk in a lateral direction,
the determining of whether to execute the proper response is performed when the collision risk is determined to be higher than the preset threshold value in both the longitudinal direction and lateral direction,
the changing of the condition for determining the collision risk is changing a condition for determining the collision risk in the lateral direction, and
the treating is treating, in the determining of the collision risk in the lateral direction, the moving object as being present in the separate lane other than the lane in which the vehicle is present even when the moving object is present in the lane in which the vehicle is present.

12. The check device according to claim 11, wherein
in the changing of the condition for determining the collision risk,
when the other road user is present in the separate lane from the vehicle, the condition is changed by setting a condition for determining the collision risk in the lateral direction based on whether a lateral distance between the vehicle and the other road user is higher than a lateral safety distance, and
when the other road user is present in the same lane as the vehicle, the condition is changed such that the collision risk in the lateral direction is determined to be higher than the preset threshold value.

13. A system used for driving a vehicle and for displaying information using an information presentation device, which is a visual information presentation type, the system comprising:
at least one processor; and
a non-transitory computer-readable storage medium storing instructions that, when executed by the at least one processor, cause the at least one processor to cause the information presentation device to display at least one of a trajectory or a travel route predicted to be traveled by a moving object passing through a vicinity of the vehicle.

14. The system according to claim 13, wherein
the processor further causes the information presentation device to display the moving object passing through the vicinity of the vehicle superimposed on an image displaying at least one of the trajectory or the travel route.

15. The system according to claim 13, wherein
the processor further causes the information presentation device to display at least one of a longitudinal position, longitudinal speed, longitudinal acceleration, longitudinal deceleration, a lateral position, lateral speed, lateral acceleration, or lateral deceleration assumed for the moving object passing through the vicinity of the vehicle in association with at least one of the trajectory or the travel route.
